(19) United States
(12) Patent Application Publication
(10) Pub. No.: US 2024/0342599 A1
(43) Pub. Date: Oct. 17, 2024

(54) STORAGE MEDIUM, GAME SYSTEM AND GAME CONTROL METHOD

(71) Applicants: NINTENDO CO., LTD., Kyoto (JP); THE POKÉMON COMPANY, Tokyo (JP)

(72) Inventors: Katsuyoshi IRIE, Tokyo (JP); Kenichi KATO, Tokyo (JP); Hiroyuki JINNAI, Tokyo (JP); Yasunori YANAGISAWA, Tokyo (JP); Akiko KURODA, Tokyo (JP); Yoshihiro HATTA, Tokyo (JP); Masamichi ANAZAWA, Tokyo (JP); Tsunekazu ISHIHARA, Tokyo (JP); Kunimi KAWAMURA, Tokyo (JP); Tatsuya OHNO, Tokyo (JP); Makoto HIGASHI, Tokyo (JP); Yuhma OHCHI, Tokyo (JP)

(21) Appl. No.: 18/442,516

(22) Filed: Feb. 15, 2024

(30) Foreign Application Priority Data
Apr. 12, 2023 (JP) 2023-064670

(51) Int. Cl. A63F 13/493; A63F 13/48; A63F 13/69

(52) U.S. Cl. CPC A63F 13/493; A63F 13/48; A63F 13/69

(57) ABSTRACT

A non-limiting game apparatus comprises a processor, and the processor displays a main menu image at the time of starting a game. If a player determines a second mode in the main menu image, and further an episode, a game starting point selection image is displayed. The player selects and determines the starting point of a game part that is selectable from a plurality of game parts constituting a scenario in the game starting point selection image, thereby to start a play of a virtual game. If the game part being played is cleared, a next game part become playable.

### CROSS REFERENCE OF RELATED APPLICATION

This application claims a priority to Japanese Patent Application No. 2023-064670 filed on Apr. 12, 2023, and the entire contents of which are incorporated herein by reference.

### FIELD

This application discloses a storage medium, a game system and a game control method that allows a player to start a game from a starting point of a selected game part.

### BACKGROUND AND SUMMARY

In the conventional games, there is a game that is constituted with a plurality of chapters and is capable of starting the game from a selected chapter.

However, in a game that all the chapters can be selected when playing a game for the first time, for players who play the game for the first time, it is also possible to select a chapter whose contents would be incomprehensible to them if they started the game from that chapter.

This application discloses an embodiment(s) providing a novel storage medium, game system and game control method.

Moreover, this application discloses a storage medium, game system and game control method, capable of playing a game from any one of a plurality of predetermined game starting points even if the game is played for the first time, and allowing the game to be played from a further game starting point as the game progresses.

A first embodiment is one or more non-transitory computer-readable storage media having stored therein one or more game programs, wherein the game program is for a game that a scenario is sectioned into a plurality of successive game parts and a game starting point is set at a beginning of each of the plurality of game parts, wherein the game program causes one or more processors to execute game processing comprising: displaying a selection image including at least one of first-type selection user interfaces and second-type selection user interfaces, the first-type selection user interfaces corresponding to respective game parts that are playable by the player when a previous game part is cleared, the second-type selection user interfaces corresponding to respective game parts that are playable by the player irrespective of whether a previous game part is cleared; and starting the game from the game starting point of the game part corresponding to the selection user interface that is selected based on an input by the player from the selection user interfaces included in the selection image.

According to the first embodiment, it is possible to play a game from any one of a plurality of predetermined game starting points even if the game is played for the first time, and allowing the game to be played from a further game starting point as the game progresses.

A second embodiment is the storage medium according to the first embodiment, wherein the game processing further comprising: determining based on an input by the player either a first game starting method or a second game starting method as a method of starting the game; displaying the selection image to allow the player to select the selection user interface based on an input by the player, and starting the game from the game starting of the game part corresponding to the selection user interface that is selected by the player, when the first game starting method is determined; and starting the game from the starting point of a first game part of the scenario, when the second game starting method is determined.

According to the second embodiment, it is possible to play the game while selecting the first game starting method or the second game starting method.

A third embodiment is the storage medium according to the second embodiment, wherein the game processing further comprising: starting the game from the starting point of the first game part of the scenario without displaying the selection image, when the second game starting method is determined.

According to the third embodiment, it is possible to play the game without selecting the game part when the second game starting method is determined. Therefore, the player that wants to play the second game starting method can start immediately the game.

A fourth embodiment is the storage medium according to the second embodiment, wherein the game processing further comprising: displaying the selection image including the first-type selection user interfaces corresponding to the game part that the previous game part is cleared in the game that is started by the first game starting method and to the game part that the previous game part is cleared in the game that is started by the second game starting method.

According to the fourth embodiment, it is possible to play in the first game starting method from the game part that is a continuation of the game part cleared by the second game start method.

A fifth embodiment is the storage medium according to the fourth embodiment, wherein the game processing further comprising: displaying a first saving image including a plurality of first-type save slots to allow the player to select based on an input by the player, and storing the first-type save slot selected by the player and the save data of the game in association with each other, when saving that saves game data is instructed by the player during execution of the game that is started by the first game starting method; and displaying a second saving image including a plurality of second-type save slots to allow the player to select based on an operation by the player, and storing the second-type save slot selected by the player and the save data of the game in association with each other, when the saving is instructed by the player during execution of the game that is started by the second game starting method.

According to the fifth embodiment, it is possible to avoid the save data from being erroneously written over the save data according to the other game starting method.

A sixth embodiment is the storage medium according to the fifth embodiment, wherein the game processing further comprising: displaying either a first loading image that includes the first-type save slots or a second loading image that includes the second-type save slots, when loading that reads-in the save data is instructed by the player; resuming the game based on the save data corresponding to the first-type save slot that is selected based on a selection input by the player when the first loading image is being displayed; displaying the second loading image according to an image change input by the player, when the first loading image is being displayed; resuming the game based on the save data corresponding to the second-type save slot that is selected based on a selection input by the player, when the second loading image is being displayed; and displaying the first loading image according to an image change input by the player, when the second loading image is being displayed.

According to the sixth embodiment since changeable loading images is prepared for each game starting method, it is possible to search easily a desired save slot or save data.

A seventh embodiment is the storage medium according to the sixth embodiment, wherein the game processing further comprising: displaying the first loading image, when the save data stored at last is the save data regarding the game that is started by the first game starting method; and displaying the second loading image, when the save data stored at last is the save data regarding the game that is started by the second game starting method.

According to the seventh embodiment, since the loading image for the game starting method that is most likely to be selected is displayed, it is easy to find the desired save slot or save data.

An eighth embodiment is the storage medium according to the sixth embodiment, wherein the game processing further comprising: displaying the first loading image, when the game executed at last is the game that is started by the first game starting method; and displaying the second loading image, when the game executed at last is the game that is started by the second game starting method.

According to the eighth embodiment, since the loading image for the game starting method that is most likely to be selected is displayed, it is easy to find the desired save slot or save data.

A ninth embodiment is the storage medium according to the sixth embodiment, wherein the game processing further comprising: displaying the first loading image when the save data read-in at last is the save data regarding the game that is started by the first game starting method; and displaying the second loading image when the save data read-in at last is the save data regarding the game that is started by the second game starting method.

According to the ninth embodiment, since the loading image for the game starting method that is most likely to be selected is displayed, it is easy to find the desired save slot or save data.

A tenth embodiment is the storage medium according to the sixth embodiment, wherein the plurality of first-type save slots include a first-type automatic save slot that is a slot corresponding to the save data regarding automatic saving, and the plurality of second-type save slots include a second-type automatic save slot that is a slot corresponding to the save data regarding automatic saving, wherein the game processing further comprising: storing automatically the save data in association with the first-type automatic save slot, when an event that the save data of the game is to be saved during execution of the game that is started by the first starting method; and storing automatically the save data in association with the second-type automatic save slot, when an event that the save data of the game is to be saved during execution of the game that is started by the second starting method.

According to the tenth embodiment, when the save data is to be stored automatically, the save data is stored in association with the automatic save slot according to the game starting method of the game that is being executed, and therefore, it is possible to avoid the save data from being stored in association with an erroneous save slot.

An eleventh embodiment is the storage medium according to the first embodiment, wherein the game processing further comprising: displaying the selectin image that includes information regarding the game part corresponding to the selection user interface.

According to the eleventh embodiment, it is possible to easily find a desired game starting point.

A twelfth embodiment is the storage medium according to the eleventh embodiment, wherein the information regarding the game part includes at least one of a number of the game part corresponding to the selection user interface and a title of the game part.

According to the twelfth embodiment, it is possible to easily find a desired game starting point.

A thirteenth embodiment is the storage medium according to the eleventh embodiment, wherein the information regarding the game part includes at least either a description of the game part corresponding to the selection user interface selected based on an input by the player or an image regarding the game part corresponding to the selection user interface.

According to the thirteenth embodiment, since the detailed information regarding the game part corresponding to the selection user interface being selected, it is possible to easily determine whether the selected game part is the desired game part.

A fourteenth embodiment is the storage medium according to the first embodiment, wherein the game processing further comprising: displaying the selection image not including the plurality of second-type selection user interfaces, when at least a predetermined game part including a first game part of the scenario is not cleared; and displaying the selection image including the plurality of second-type selection user interfaces, when the predetermined game part is cleared.

According to the fourteenth embodiment, since the selection image including the plurality of second-type selection user interfaces is displayed when the predetermined game part is cleared, it is possible to include the game content intended to show to the player in the predetermined game part.

A fifteenth embodiment is the storage medium according to the first embodiment, wherein the game processing further comprising: displaying the selection image including the plurality of second-type selection user interfaces as user interfaces each of which cannot be selected by the player, when at least a predetermined game part including a first game part of the scenario is not cleared; and displaying the selection image including the plurality of second-type selection user interfaces as user interfaces each of which can be selected by the player, when the predetermined game part is cleared.

According to the fifteenth embodiment, since the selection image including the plurality of second-type selection user interfaces is displayed when the predetermined game part is cleared, it is possible to include the game content intended to show to the player before execution of the second game starting method in the predetermined game part.

A sixteenth embodiment is the storage medium according to first embodiment, wherein the game processing further comprising: displaying a mode selection image including a first mode selection user interface corresponding to the first game starting method and a second mode selection user interface corresponding to the second game starting method; determining based on an input by the player either the first game starting method or the second game starting method as a game starting method; displaying the mode selection image not including the first mode selection user interfaces, when at least a predetermined game part including a first game part of the scenario is not cleared; and displaying the mode selection image including the first mode selection user interfaces, when the predetermined game part is cleared.

A seventeenth embodiment is a game system comprising: one or more processors; and one or more memories including one or more programs that cause the one or more processors to execute game processing comprising: displaying a selection image including a selection user interface that is designated according to an input by a player from first-type selection user interfaces and second-type selection user interfaces, the first-type selection user interfaces corresponding to respective game parts that become playable by the player after a previous game part is cleared, the second-type selection user interfaces corresponding to respective game parts that are playable by the player irrespective of whether a previous game part is cleared; and starting the game from the game starting point of the game part corresponding to the selection user interface that is selected based on an input by the player from the selection user interfaces included in the selection image.

An eighteenth embodiment is a game control method executing game processing of a game that a scenario is sectioned into a plurality of successive game parts and a game starting point is set at a beginning of each of the plurality of game parts, wherein the one or more processors execute: displaying a selection image including a selection user interface that is designated according to an input by a player from first-type selection user interfaces and second-type selection user interfaces, the first-type selection user interfaces corresponding to respective game parts that become playable by the player after a previous game part is cleared, the second-type selection user interfaces corresponding to respective game parts that are playable by the player irrespective of whether a previous game part is cleared; and starting the game from the game starting point of the game part corresponding to the selection user interface that is selected based on an input by the player from the selection user interfaces included in the selection image.

According also to the seventeenth embodiment and the eighteenth embodiment, similar to the first embodiment, it is possible to play a game from any one of a plurality of predetermined game starting points even if the game is played for the first time, and allowing the game to be played from a further game starting point as the game progresses.

The features, aspects and advantages of the embodiment(s) will become more apparent from the following detailed description when taken in conjunction with the accompanying drawings.

### BRIEF DESCRIPTION OF THE DRAWINGS

FIG. 1 is a block diagram showing non-limiting example electric structure of a game apparatus.

FIG. 2 is a view showing a non-limiting example main menu image displayed on a display device of the game apparatus shown in FIG. 1.

FIG. 3 is a view showing a non-limiting example game image displayed on the display device of the game apparatus shown in FIG. 1.

FIG. 4 is a view showing a non-limiting first example episode selection image displayed on the display device of the game apparatus shown in FIG. 1.

FIG. 5 is a view showing a non-limiting second example episode selection image displayed on the display device of the game apparatus shown in FIG. 1.

FIG. 6 is a view showing a non-limiting first example game starting point selection image displayed on the display device of the game apparatus shown in FIG. 1.

FIG. 7 is a view showing a non-limiting second example game starting point selection image displayed on the display device of the game apparatus shown in FIG. 1.

FIG. 8 is a view showing a non-limiting first example loading image displayed on the display device of the game apparatus shown in FIG. 1.

FIG. 9 is a view showing a non-limiting second example loading image displayed on the display device of the game apparatus shown in FIG. 1.

FIG. 10 is a view showing a non-limiting first example saving image displayed on the display device of the game apparatus shown in FIG. 1.

FIG. 11 is a view showing a non-limiting second example saving image displayed on the display device of the game apparatus shown in FIG. 1.

FIG. 12 is a view showing a non-limiting example memory map of a RAM incorporated in the game apparatus shown in FIG. 1.

FIG. 13 is a flowchart showing a first part of non-limiting example overall processing of a virtual game of a processor incorporated in the game apparatus shown in FIG. 1.

FIG. 14 is a flowchart showing a second part of the non-limiting example overall processing of the virtual game of the processor incorporated in the game apparatus shown in FIG. 1, following FIG. 13.

FIG. 15 is a flowchart showing a third part of the non-limiting example overall processing of the virtual game of the processor incorporated in the game apparatus shown in FIG. 1, following FIG. 14.

FIG. 16 is a flowchart showing a fourth part of the non-limiting example overall processing of the virtual game of the processor incorporated in the game apparatus shown in FIG. 1, following FIG. 13.

FIG. 17 is a flowchart showing a fifth part of the non-limiting example overall processing of the virtual game of the processor incorporated in the game apparatus shown in FIG. 1, following FIG. 16.

FIG. 18 is a flowchart showing a first part of non-limiting example loading processing by the processor incorporated in the game apparatus shown in FIG. 1.

FIG. 19 is a flowchart showing a second part of the non-limiting example loading processing by the processor incorporated in the game apparatus shown in FIG. 1, following FIG. 18.

FIG. 20 is a flowchart showing non-limiting example saving processing by the processor incorporated in the game apparatus shown in FIG. 1.

FIG. 21 is a view showing another non-limiting example game starting point selection image displayed on the display device of the game apparatus shown in FIG. 1.

### DETAILED DESCRIPTION OF NON-LIMITING EXAMPLE EMBODIMENTS

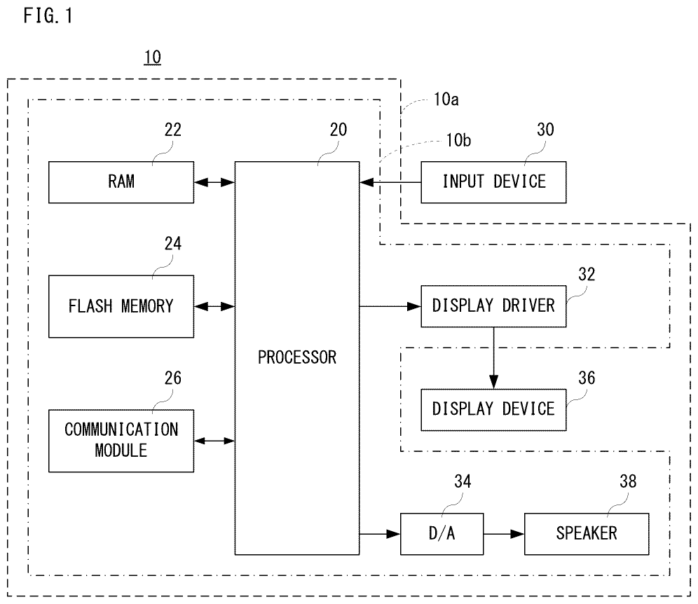

With reference to FIG. 1, a game apparatus 10 that is a non-limiting example information processing apparatus includes a processor 20, and the processor 20 is connected with a RAM 22, a flash memory 24, a communication module 26, an input device 30, a display driver 32 and a D/A converter 34. Moreover, the display driver 32 is connected with a display device 36, and the D/A converter 34 is connected with a speaker 38.

The processor 20 is in charge of overall control of the game apparatus 10. The processor 20 may be an SoC (System-on-a-chip) that incorporates therein functions of a CPU and a GPU. The RAM 22 is a volatile storage medium and is used as a working memory and a buffer memory for the processor 20. The flash memory 24 is a non-volatile storage medium, and is used in order to store a various kinds of application programs, store (save) various kinds of data. For example, the application program and required data are read from the flash memory 24 to be stored in the RAM 22.

However, the application corresponds to applications regarding various kinds of information processing, such as a manual display application, a game application, a document creation application, an email application, a drawing application, a character practice application, a language training application, a learning application, etc.

The communication module 26 has a function that connects to a wireless LAN according to a system conforming to a standard of IEEE 802.11. b/g, for example. Therefore, the processor 20 transmits or receives data to or from a further apparatus via an access point and a network such as Internet using the communication module 26, for example. For example, the further apparatus is a computer such as a server or other game apparatus 10. However, it is possible to directly transmit or receive data to or from such a further apparatus using the communication module 26.

However, in different from the function of connecting to a wireless LAN, the communication module 26 may have a function of performing a short-distance wireless communication. Specifically, the communication module 26 has a function that performs transmitting/receiving of an infrared ray signal with a further apparatus by a predetermined communication system (e.g., an infrared ray system), and a function that performs a wireless communication with the same kind of game apparatuses in accordance with a predetermined communication protocol (e.g., a multilink protocol). In this case, the processor 20 can directly transmit or receive data to or from other same kinds of game apparatuses using the communication module 26, for example. However, instead of the short-distance wireless communication of the infrared ray system, a short-distance wireless communication according to a further wireless communication standard, such as Bluetooth (registered trademark) may be performed.

The input device 30 is a game controller provided with various kinds of push buttons, keys or switches that are provided on the game apparatus 10, for example, and is used by a user or player (hereinafter, referred to as “player”) for various kinds of operations, such as menu selection, instructions in an application. For example, the game controller is provided with an A button, a B button, an X button, a Y button, an L button, an R button, a cross button (and/or a slide stick), etc. However, in a case of a portable game apparatus 10, in addition to the push buttons, keys or switches, a touch panel may be provided as the input device 30.

The display driver 32 is used in order to display various kinds of images, such as a menu image, a game image, etc. on the display device 36 under instructions of the processor 20. Although illustration is omitted, the display driver 32 incorporates therein a video RAM.

The D/A converter 34 converts sound data given from the processor 20 into an analog audio signal, and outputs the same to the speaker 38. However, the sound data may be data regarding the sound, such as a sound generated by a character or object, a sound effect and a BGM.

In addition, the electric structure of the game apparatus 10 shown in FIG. 1 is a mere example, and should not need to be limited to this. For example, the communication module 26 may be omitted.

Moreover, the input device 30 may be a game controller provided separately from a main body apparatus 10a of the game apparatus 10, and connected communicably to the processor 20 with a wire or wireless. In this case, the game apparatus 10 constitutes a game system that the main body apparatus 10a and the input device 30 are communicably connected to each other.

Furthermore, in addition to the input device 30, the display device 36 may also be provided separately from a main body apparatus 10b of the game apparatus 10, and connected communicably to the processor 20 with a wire or wireless. In this case, the game apparatus 10 constitutes a game system that the main body apparatus 10b, the input device 30 and the display device 36 are communicably connected to each other. Moreover, as the display device 36, a stationary monitor such as an LCD or an organic EL can be used.

Furthermore, as the game apparatus 10, it is possible to use a game dedicated machine of a portable type or stationary type as well as other information processing apparatuses capable of functioning as a game machine, such as a personal computer, a tablet terminal, a wearable terminal, a cellular phone and a smartphone.

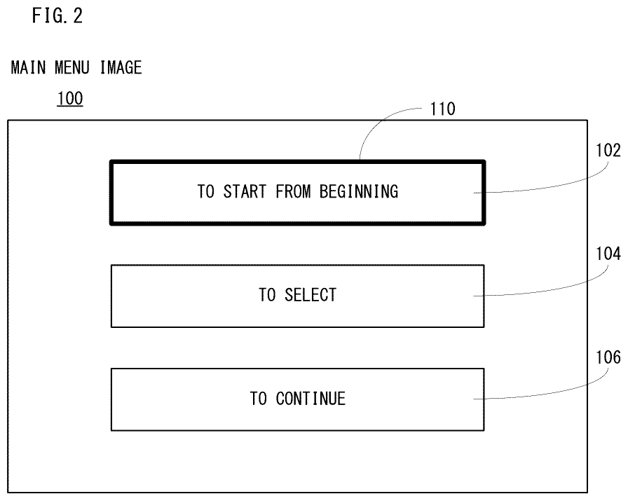

FIG. 2 is a view showing a non-limiting example main menu image 100 displayed on the display device 36 of the game apparatus 10 shown in FIG. 1.

If the player instructs execution of the game application of the virtual game according to the embodiment, the main menu image 100 is displayed on the display device 36. The virtual game of the embodiment is a game that is advanced in accordance with a scenario, and constituted by a plurality of successive game parts (e.g., chapter). An order is set for all the game parts from the beginning to the end of the scenario. The game part means a section that starts at a point in the scenario and ends at another point in the scenario. Moreover, in the embodiment, the scenario is sectioned for each of a plurality of game parts. As an example, the scenario is sectioned into five stories (i.e., episodes) of the episode 0 (zero), the episode 1 (one), the episode 2 (two), the episode 3 (three), the episode 4 (four) and the episode 5 (five). Each episode is constituted by a plurality of successive game parts. The number of the game parts of each episode may be the same or may differ. Naturally, the number of the game parts that constitutes each episode is less than the total number of the game parts that make up the scenario of the game.

However, before the main menu image 100 is displayed, the movie on the scenario of the virtual game may be displayed on the display device 36.

The main menu image 100 shown in FIG. 2 is an image for determining a starting method of the virtual game and resumption of the virtual game. In the virtual game of the embodiment, a plurality of game starting methods (“to start from beginning” and “to select”) and the game resumption (“to continue”) are provided.

“To select” is a game starting method to start the game with a first mode (equivalent to “first starting method”), and a starting method to start a play of the virtual game from a starting point of the game part that the player selected (equivalent to “game starting point”).

“To start from beginning” is a game starting method to start the game with a second mode (equivalent to “second starting method), and a starting method to start a play of the virtual game from a starting point of the first game part of the scenario without selecting the starting point of the game part.

“To continue” is a game starting method that the game data of the first mode or the second mode having been the saved (also referred to as “save data”) is loaded and a play of the virtual game is resumed at a save point by using the game data of the first mode or the second mode having been loaded.

However, the game data of the first mode means the game data generated and updated when the virtual game is played in the first mode. Moreover, the game data of the second mode means the game data generated and updated when the virtual game is played in the second mode. The same applies below.

The main menu image 100 is provided with three buttons 102, 104 and 106 for selecting any of the starting methods of the virtual game and the resumption of the virtual game. The button 102 is a user interface for selecting the second mode (hereinafter, “selection UI”; the same applies below). The button 104 is a selection UI for selecting the first mode. The button 106 is a selection UI for selecting resumption of a play of the virtual game from the saved point.

In addition, when there is no saved game data, the button 106 may be made non-operable or hidden.

Moreover, the main menu image 100 is provided with a cursor 110. The cursor 110 is a square frame having the same shape and the same size as those of each of the buttons 102-106. In an example shown in FIG. 2, the cursor 110 designates the button 102. That is, it is a state where the button 102, i.e., the second mode is selected. The cursor 110 is moved by operating an up-direction button or a down-direction button of the cross button of the input device 30. Therefore, it is possible to select another button 104 or 106. If the A button of the input device 30 is operated, it is determined that the virtual game is to be played with the selected game mode.

If the A button is operated in a state where the button 102 is being designated by the cursor 110, i.e., a state where the second mode is being selected, the second mode is determined as the game mode. That is, the playing the virtual game from the beginning is determined. Here, the beginning of the virtual game means a starting point of the first game part of the episode 0.

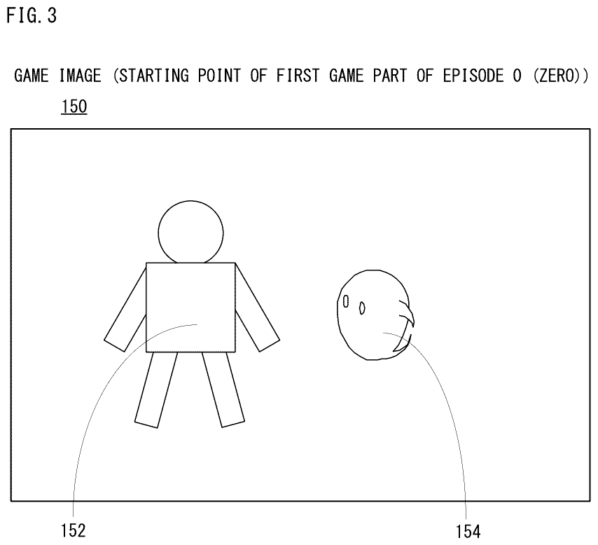

FIG. 3 is a view showing a non-limiting example game image 150 of the starting point of the first game part of the episode 0. The game image 150 of FIG. 3 is displayed with a player character 152 and a non-player character 154. The background is omitted. The player makes the virtual game progress in accordance with the scenario by causing the player character 152 to move, the player character 152 to talk with the non-player character 154, the player character 152 to investigate an object arranged in a virtual space, the player character 152 to acquire an item arranged in the virtual space, and the player character 152 to use an item that the player character 152 possesses.

In the second mode, a certain game part becomes playable by the player after the previous game part is cleared. That is, in the second mode, when clearing the game part being played, a game part in a next order is released. Therefore, if the first game part of the episode 0 is cleared, the second game part of the episode 0 becomes playable. Each game part after the third game part of the episode 0 becomes playable sequentially in the same way. If the game part at the end of the episode 0 is cleared, the episode 0 becomes to be cleared, and the first game part of the episode 1 becomes playable. Furthermore, if the game part is cleared up to the end of the episode 1, the episode 1 becomes to be cleared and the first game part of the episode 2 becomes a playable. The same is true for the episode 3 and subsequent episodes. When all the game parts are cleared up to the end of the last episode, i.e., the episode 4, it becomes clear of the virtual game.

Moreover, as shown in FIG. 2, if the A button of the input device 30 is operated in a state where the button 104 is being designated by the cursor 110, i.e., in a state where the first mode is being selected, the first mode is determined as the game mode. That is, it is determined to play the virtual game from the starting point of one game part selected among one or more game parts that are selectable by the player out of the plurality of game parts constituting the scenario of the virtual game irrespective of whether the previous game part has been cleared. Therefore, an image for determining the episode and the starting point (or game part) is displayed on the display device 36. In the embodiment, after the episode is determined, the starting point of the game part (i.e., game starting point) is determined.

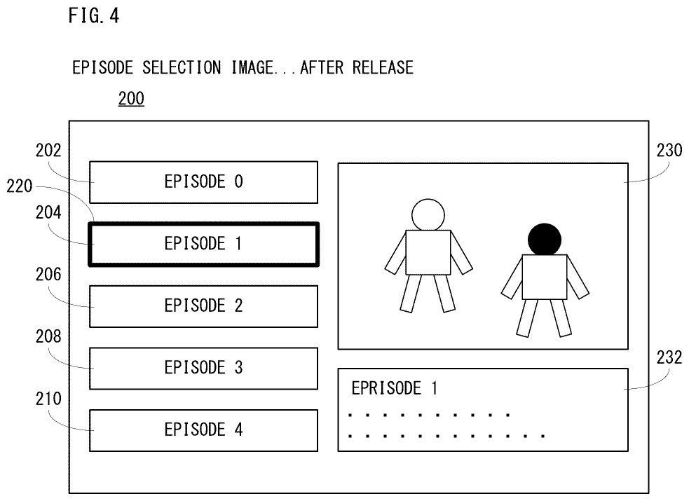

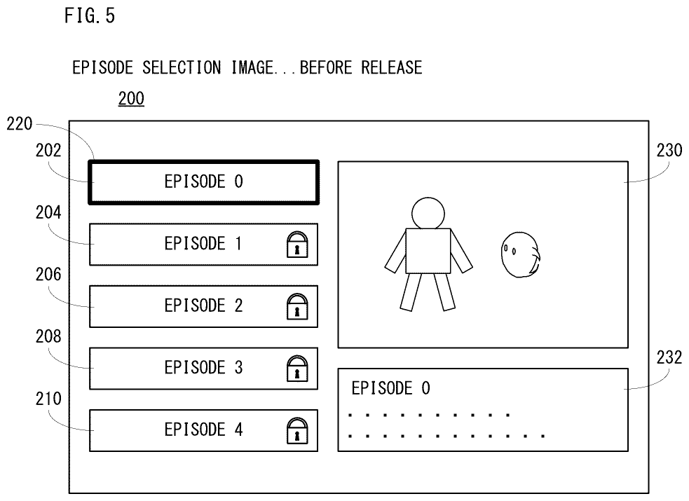

FIG. 4 is a view showing a non-limiting example image 200 for selecting and determining an episode (hereinafter, referred to as “episode selection image”). FIG. 5 is a view showing another non-limiting example episode selection image 200.

As shown in FIG. 4 and FIG. 5, in the episode selection image 200, a plurality of buttons 202, 204, 206, 208 and 210 are provided in the left side, and a display area 230 and a display area 232 are provided in the right side. Moreover, the episode selection image 200 is provided with a cursor 220. The cursor 220 is a square frame having the same shape and the same size as those of each of the buttons 202-210.

Each of the buttons 202-210 is a selection UI for selecting an episode. The display area 230 is an area for displaying an image corresponding to the game image 150 regarding the starting point of the first game part of the episode corresponding to the button designated by the cursor 220 (i.e., “any one of the buttons 202-210, which is the same for the episode selection image 200). However, in the display area 230, an image corresponding to the game image 150 regarding each of the starting points of one or more playable game parts among a plurality of game parts constituting the episode corresponding to the button designated by the cursor 220 may be displayed sequentially. The display area 232 is an area for displaying the information on the episode corresponding to the button designated by the cursor 220. In the embodiment, the information on the episode includes a character string indicative of the episode corresponding to the button designated by the cursor 220 (“episode 1” in FIG. 4 and “episode 0” in FIG. 5), and the contents of a description of this episode (e.g., outline). In FIG. 4 and FIG. 5, it is indicated that the outline is being displayed by displaying a plurality of dots. However, instead of displaying the character string indicative of the episode, or in addition to displaying the character string indicative of the episode, it is possible to display a character string indicative of a title applied to this episode.

However, the episode selection image 200 shown in FIG. 4 and FIG. 5 is mere example, and should not need to be limited. For example, the character string indicative of the episode in the display area 232 may not be displayed.

Since not only the buttons 202-210 for selecting an episode but also an image corresponding to the game image 150 of the starting point of the first game part of the episode corresponding to the selected button and the outline of the episode are displayed in the episode selection image 200, it is possible for the player to know the episode and the information on at least the first game part of that episode. Therefore, the player can select an episode easily.

Moreover, in an example of the episode selection image 200 shown in FIG. 4, all episodes are selectable, i.e., playable, and all episodes from the episode 0 to the episode 4 are released. Therefore, any of the buttons 202-210 is selectable.

However, in the virtual game of this embodiment, until the episode 0 is cleared, the episode 1 and subsequent episodes cannot be played, and thus, the episode 1 through the episode 4 are not released. Therefore, in an example of the episode selection image 200 shown in FIG. 5, the button 202 is selectable and the buttons 204-210 are cannot be selected. On the episode selection image 200 shown in FIG. 5, an image of a lock is displayed on each of the buttons 204-210, and therefore, it is impossible to turn on the buttons 204-210. This is an example, until the episode 0 is cleared, by graying the buttons 204-210 out, or by not displaying the buttons 204-210, it may be indicated that the episodes corresponding to these buttons are not released.

In the virtual game of this embodiment, the episode 1 and subsequent episodes are not released until the episode 0 cleared. That is, it is necessary to certainly clear the episode 0. Therefore, it is possible to include, in the episode 0, the contents of the virtual game intended to show to the player. As the contents of the virtual game, an explanation of the character that appears in the virtual game, and an explanation of the operation method correspond. Therefore, the player can know the contents of the virtual game while playing the virtual game.

Moreover, in the embodiment, since the episode 1 and subsequent episodes are not released until the episode 0 is cleared, the button 104 may not be selectable until the episode 0 is cleared by graying the button 104 out or by making the button 104 be hidden in the main menu image 100.

Furthermore, the episode 0 is a prologue constituted by at least one (in the example, four) predetermined game parts including the first game part of the scenario. Therefore, it is possible to include, in the prologue, the contents of the virtual game intended to show to the player.

Moreover, the scenario may not be sectioned into a plurality of stories (episodes), in the first mode, instead of the first game part of each of the episodes 1-4 being playable, it may be possible to play the game parts in a predetermined order from the beginning. For example, the first game part, the eleventh game part and the twenty-first game part may be set playable from the beginning.

Moreover, in this embodiment, when the second mode is selected, a play of the virtual game is started from the first game part of the scenario without allowing the player to select the starting point of the game part; however, when the second mode is selected, a game starting point selection image including only a selection UI corresponding to the first game part of the scenario may be displayed, so that the game can be started based on the selection of this selection UI.

In the episode selection image 200, the cursor 220 is moved by operating the up-direction button or the down-direction button in the cross button of the input device 30. Therefore, in the episode selection image 200 shown in FIG. 4, it is possible to select another button 202, 206, 208 or 210. Moreover, in the episode selection image 200 shown in FIG. 5, it is possible to select another button 204, 206, 208 or 210

Selecting and determining the starting point of the game part that starts the play of the virtual game in the determined episode is determined by operating the A button of the input device 30.

Moreover, if the B button of the input device 30 is operated when the episode selection image 200 is being displayed, selection and determination of that episode is stopped to be returned to the main menu. That is, the episode selection image 200 is hidden, and the main menu image 100 becomes to be displayed.

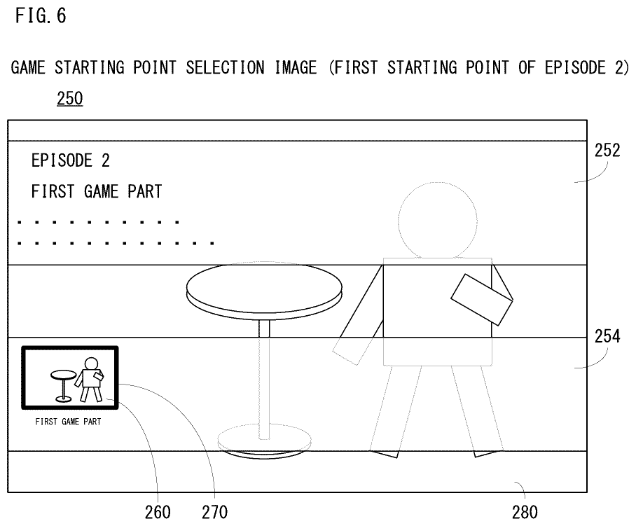

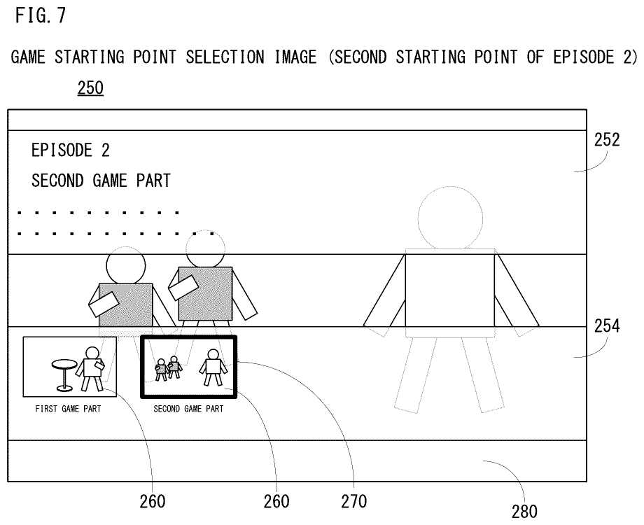

FIG. 6 is a view showing a non-limiting example game starting point selection image 250. FIG. 7 is a view showing another non-limiting example game starting point selection image 250. As shown in FIG. 6 and FIG. 7, in the game starting point selection image 250, a display area 252 and a display area 254 are provided.

The display area 252 is an area for displaying a character string indicative of the determined episode (in FIG. 6 and FIG. 7, “episode 2”), a character string regarding the number of the game part including the starting point being selected (in FIG. 6, “first game part”, and in FIG. 7, “second game part”), and the outline regarding the game part including the starting point being selected. In FIG. 6 and FIG. 7, it is indicated that the outline is being displayed by displaying a plurality of dots.

The display area 254 is an area for displaying one or more buttons 260 corresponding to respective ones of one or more starting points that are selectable. A thumbnail image of the game image 150 at the starting point is displayed on each of the one or more buttons 260. Moreover, a cursor 270 for selecting the button 260 is provided in the game starting point selection image 250. The cursor 270 is a square frame having the same shape and the same size as those of the button 260. However, since the button 260 is provided only one in FIG. 6, this button 260 is being designated by the cursor 270.

Furthermore, in the game starting point selection image 250, an image 280 on a game part including the starting point corresponding to the button 260 designated by the cursor 270 is displayed in a rear side of the display area 252 and the display area 254. As an example, the image 280 is an image equivalent to the game image 150 regarding the starting point corresponding to the button 260 designated by the cursor 270.

When the button 260 designated by the cursor 270 is changed, the character string indicative of the number (e.g., “X”) regarding the game part that includes the starting point corresponding to the changed button 260, i.e., the starting point being selected (i.e., X-th game part) and the outline regarding the game part including the starting point being selected are displayed in the display area 252, and the image 280 on a game part including the starting point being selected is displayed. That is, the game starting point selection image 250 is updated.

Since the background of the display area 252 and the display area 254 is made to be translucent, portions of image 280 behind display area 252 and display area 254 are also visible.

Also in the first mode, similar to the second mode, a certain game part becomes playable by the player after the game part previous one is cleared. Moreover, in the first mode, when the episode 0 is cleared, the episode 1 and subsequent episodes are released. At this time, only the first game part of each of the episode 1 to the episode 4 is made to be playable. Therefore, the game starting point selection image 250 shown in FIG. 6 is displayed on the display device 36 if the episode 2 is determined in the episode selection image 200 when all the game parts of the episode 0 are cleared at least. Moreover, the game starting point selection image 250 shown in FIG. 7 is displayed on the display device 36 if the second episode is determined in the episode selection image 200 when the first game part of the second episode is cleared.

In the game starting point selection image 250 shown in FIG. 7, by operating the left-direction or the right-direction button of the cross button in the input device 30, the cursor 270 is moved and another button 260 can be selected. When the cursor 270 is moved, the image 280 is changed to an image 280 of the starting point corresponding to the button 260 designated by the cursor 270 after movement.

If the A button of the input device 30 is operated when the game starting point selection image 250 is being displayed, the virtual game is started from the starting point corresponding to the button 260 designated by the cursor 270. However, when the virtual game is started, the game image 150 of the starting point corresponding to the button 260 designated by the cursor 270 is displayed on the display device 36.

As the information on the game part that includes the starting point corresponding to the button 260, in the game starting point selection image 250, the outline of the game part, the number of the game part and the image equivalent to the game image 150 of the starting point (the image displayed on the button 260 and the image 280) are included, the player can easily find a desired starting point.

However, in the game starting point selection image 250, instead of displaying the character string indicative of the number of the game part that includes the starting point corresponding to the button 260, or in addition to the character string indicative of the number of the game part, it may be possible to display a character string indicative of a title applied to the game part that includes this starting point. Moreover, in the game starting point selection image 250, it is also possible to display the date (hours may be included) within the virtual game corresponding to the starting point. Moreover, when the game part of only a movie is provided, it may be possible to display the information that indicates whether the game part is a game part regarding the movie.

Moreover, although the image 280 equivalent to the game image 150 regarding the starting point corresponding to the button 260 that is designated by the cursor 270 is displayed in the game starting point selection image 250 shown in FIG. 6 and FIG. 7, should not need to be limited. The image 280 may be an image of a character that appears for the first time in the game part including the starting point corresponding to the button 260 designated by the cursor 270 or an image corresponding to another game image 150 displayed in this game part.

Furthermore, if the B button of the input device 30 is turned on when the game starting point selection image 250 is being displayed, the process returns to the selection and determination of the episode. That is, the game starting point selection image 250 is hidden, and the episode selection image 200 becomes to be displayed.

Moreover, if the A button of the input device 30 is operated in a state where the button 106 is being designated by the cursor 110 as shown in FIG. 2, resuming the play of the virtual game from the save point is determined. That is, it is determined that the selected game data out of the saved game data is loaded to play the virtual game from the save point. Therefore, an image for loading the saved game data is displayed on the display device 36.

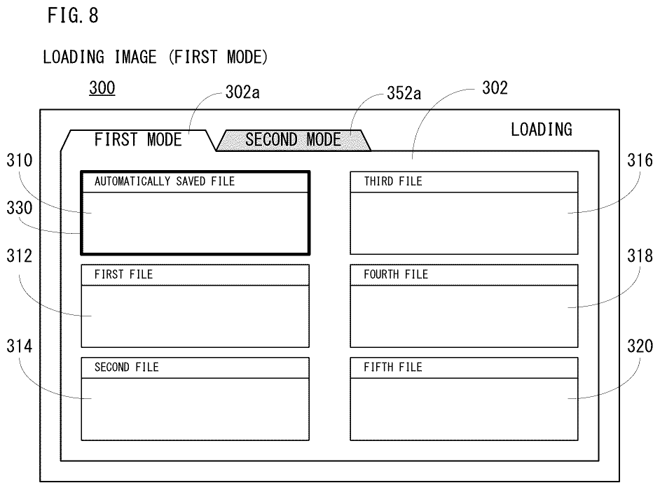

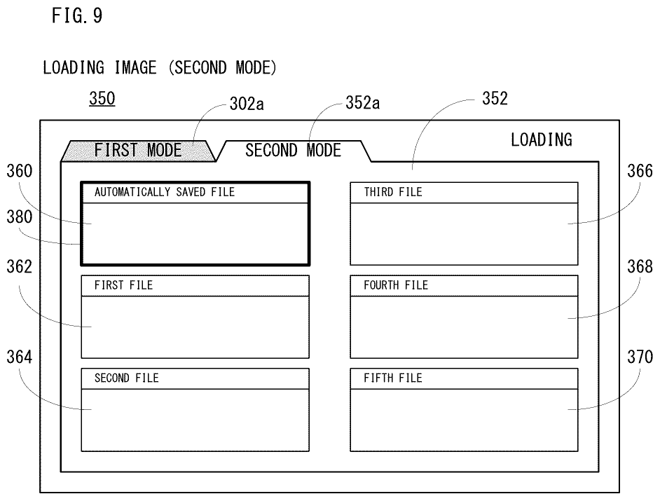

FIG. 8 is a view showing a non-limiting example loading image 300 for loading the game data of the first mode. FIG. 9 is a view showing a non-limiting example loading image 350 for loading the game data of the second mode.

If it is determined that the play of the virtual game from the saved point is to be resumed, loading processing of the game data is started and the loading image 300 or the loading image 350 according to the game mode that the game data is saved last time is displayed on the display device 36. That is, in the beginning when the loading processing is started, the loading image 300 or the loading image 350 regarding the game mode that the game data is saved last time is displayed.

At this time, the cursor is displayed on a save slot associated with the game data saved last time. When the loading image 300 is displayed, a cursor 330 is displayed on the save slot 310, 312, 314, 316, 318 or 320 associated with the game data saved last time. The cursor 330 is a square frame having the same shape and the same size as those of each of the save slots 310-320. When the loading image 350 is displayed, a cursor 380 is displayed on the save slot 360, 362, 364, 366, 368 or 370 associated with the game data saved last time. The cursor 380 is a square frame having the same shape and the same size as those of each of the save slots 360-370.

Therefore, information indicating whether the image that had been displayed when the game data saved last time is the loading image 300 or the loading image 350, i.e., data indicating the save slot that the game data is saved last time (either 410-420 or either 460-470, described later) is included in, for example, a system file of the virtual game, and stored in the flash memory 24. Therefore, when displaying the loading image 300 or the loading image 350, the data that is included in the system file and indicates the save slot that the game data is saved last time is referred to.

Here, the system file means data of a record of the virtual game and data regarding settings in the virtual game. As the data of the record of the virtual game, data of the game part having been cleared (game part clear data 504e described later), data indicating the game mode of the game data loaded last time and the save slot with which that game data is associated (last time loading execution data 504f described later), data indicating the save slot with which the game data saved last time regarding each of the first mode and the second mode (last time save execution data 504g described later) are associated, etc. correspond. As the data regarding the settings of the virtual game, data of a displaying speed of messages to be displayed when playing the virtual game, data of a moving speed of the player character 152, data indicating whether the BGM is to be turned on/off, etc. correspond.

Thus, at the beginning when the loading processing is started, the loading image 300 or the loading image 350 of the game mode that is more likely to be selected is displayed, and therefore, it is easy to find the desired save slot. This also applies to a case where execution of loading is instructed during playing the virtual game.

However, this is an example, and the loading image 300 or the loading image 350 of the game mode that is selected when the virtual game is played last time may be displayed instead of displaying the loading image 300 or the loading image 350 that the game data is saved last time. In this case, instead of the last time loading execution data 504f, data indicating the game mode that is selected when the virtual game is played last time is included in the system file.

Moreover, instead of displaying the loading image 300 or the loading image 350 that the game data is saved last time, the loading image 300 or the loading image 350 of the game mode when the game data is loaded last time may be displayed. In this case, it is not necessary to include the last time loading execution data 504f in the system file.

Moreover, the loading image 300 and the loading image 350 are exchangeable by an operation by the player. Therefore, the player can start (or resume) the first mode or the second mode from the point that the virtual game is saved. This also applies to a case where the loading processing is executed during the play of the virtual game, as described later.

As shown in FIG. 8, a folder image 302 is provided in the loading image 300, and a character string indicative of the first mode is displayed in a tabulation 302a of the folder image 302. Moreover, a plurality of save slots 310, 312, 314, 316, 318 and 320 are provided in the folder image 302. Moreover, a cursor 330 is provided in the loading image 300. As described above, in the beginning when the loading image 300 is displayed, the cursor 330 designates the save slot that the game data is loaded last time.

The save slot 310 is an image corresponding to a storage area of the flash memory 24 that the game data is saved automatically when playing the virtual game in the first mode.

Other five save slots 312-320 are images corresponding to respective ones of the storage areas of the flash memory 24 that the virtual game is played in the first mode and the game data is saved according to an operation by the player.

A name is applied to each of the save slots 310-320, and a character string indicative of the name is displayed. As an example, as shown in FIG. 8, an automatically saved file, a first file, a second file, a third file, a fourth file and a fifth file are displayed. Although illustration is omitted, a character string indicative of information on the saved game data is displayed below the character string indicative of the name in each of the save slots 310-320. The information on the game data includes a date of saving the game data, an outline of the game part being played when the game data is saved, a name of the player, etc.

However, as for the save slot that the game data is not saved, the character strings indicative of the name and the information on the game data are not displayed. Alternatively, only the name may be displayed.

In the loading image 300 shown in FIG. 8, the cursor 330 is moved by operating the cross button of the input device 30, so that another save slot (in FIG. 8, either one of the save slots 312-320) can be selected. When the cursor 330 is moved, a save slot (either of 312-320) that is designated by the cursor 330 after movement is selected.

Moreover, when the A button of the input device 30 is operated in the loading image 300, the game data corresponding to either one of the save slots 310-320 designated by the cursor 330 is loaded, that is, the game data that is read from the flash memory 24 is stored in the RAM 22, and the virtual game is resumed from the point that the game data is saved. That is, the virtual game is resumed in the first mode. However, when the virtual game is resumed, the game image 150 at the point that the loaded game data is saved is displayed on the display device 36. These also apply to a case where the game data is loaded using the loading image 350.

Moreover, a tabulation 352a that is a part of a folder image 352 of the loading image 350 for the second mode is provided in the loading image 300. In the embodiment, if the R button of the input device 30 is operated when the loading image 300 is being displayed, the loading image 350 is displayed on the display device 36 instead of the loading image 300. At this time, a cursor 380 designates, as an example, the save slot in a position that is the same as the save slot having been designated in the loading image 300 before an exchange.

As shown in FIG. 9, a folder image 352 is provided in the loading image 350, and a character string indicative of the second mode is displayed on a tabulation 352a of the folder image 352. Moreover, a plurality of save slots 360, 362, 364, 366, 368 and 370 are provided in the folder image 352. Moreover, the cursor 380 is provided in the loading image 350. In the beginning when the loading image 350 is displayed, the cursor 380 designates the save slot that the game data is saved last time.

The save slot 360 is an image corresponding to a storage area of the flash memory 24 that the game data is saved automatically when playing the virtual game in the second mode.

Other five save slots 362-370 are images corresponding to respective ones of the storage areas of the flash memory 24 that the virtual game is played in the second mode and the game data is saved according to an operation by the player.

A name is applied to each of the save slots 360-370, and a character string indicative of the name is displayed. As an example, as shown in FIG. 9, an automatically saved file, a first file, a second file, a third file, a fourth file and a fifth file are displayed. Although illustration is omitted, a character string indicative of information on the saved game data is displayed below the character string indicative of the name in each of the save slots 360-370. The information on the game data includes a date of saving the game data, an outline of the game part being played when the game data is saved, a name of the player, etc.

However, as for the save slot that the game data is not saved, the character strings indicative of the name and the information on the game data are not displayed. Alternatively, only the name may be displayed.

In the loading image 350 shown in FIG. 9, the cursor 380 is moved by operating the cross button of the input device 30, so that another save slot (in FIG. 9, either one of the save slots 362-370) can be selected. When the cursor 380 is moved, a save slot (either of 362-370) that is designated by the cursor 380 after movement is selected.

Moreover, when the A button of the input device 30 is operated in the loading image 350, the game data corresponding to either one of the save slots 360-370 designated by the cursor 380 is loaded, and the virtual game is resumed from the point that the game data is saved. That is, the virtual game is resumed in the second mode.

Moreover, the tabulation 302a that is a part of a folder image 302 of the loading image 300 for the first mode is provided in the loading image 350. In the embodiment, if the L button of the input device 30 is operated when the loading image 350 is being displayed, the loading image 300 is displayed on the display device 36 instead of the loading image 350. At this time, the cursor 330 designates, as an example, the save slot in a position that is the same as the save slot having been designated in the loading image 350 before an exchange.

In order to determine, when starting the loading processing, whether to display the loading image 300 or the loading image 350 and to determine which save slot is designated by the cursor 330 or the cursor 380, the last time saving execution data 504g is included in the system file as described above.

Moreover, in the virtual game of the embodiment, if the Y button of the input device 30 is operated when playing the virtual game, the loading processing of the game data is executed, and if the X button of the input device 30 is operated, the saving processing of the game data is executed.

However, if the Y button of the input device 30 is operated when playing the virtual game, an optional image capable of instructing the execution of the loading processing or the saving processing of the game data may be displayed.

If the execution of the loading processing is instructed by the player when playing the virtual game, according to the data that indicates the save slot that the game data is loaded last time, the loading image 300 or the loading image 350 is displayed. The processing after the loading image 300 or the loading image 350 is displayed is as described above.

Moreover, in the embodiment, if the execution of the loading processing is instructed by the player when playing the virtual game, the loading image 300 or the loading image 350 is displayed according to the data indicating the save slot that the game data is saved last time; however, the loading image 300 or the loading image 350 may be displayed according to the game mode of the virtual game that is being played when the execution of the loading processing is instructed by the player.

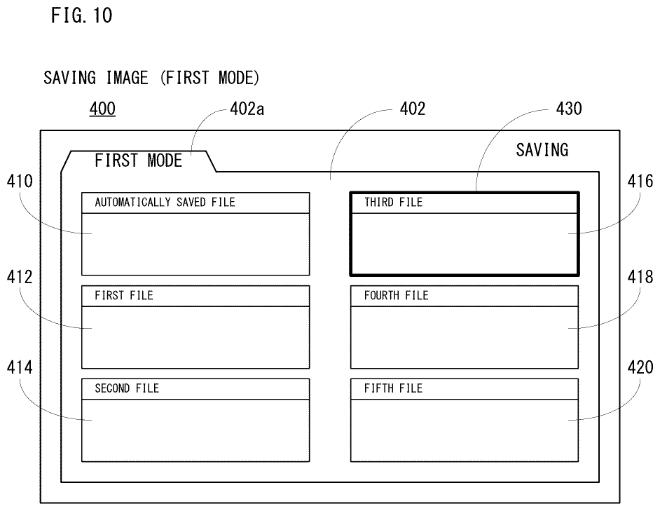

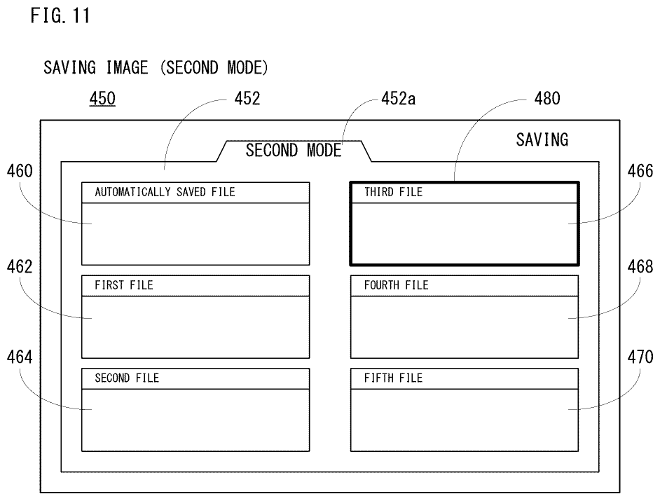

Moreover, if the execution of the saving processing is instructed by the player when playing the virtual game, the image for saving the game data is displayed. FIG. 10 is a view showing a non-limiting example saving image 400 for saving the game data of the first mode. FIG. 11 is a view showing a non-limiting example saving image 450 for saving the game data of the second mode.

In addition, the saving image 400 is displayed with a different appearance than the loading image 300, but may be displayed with the same appearance. Similarly, the saving image 450 is displayed with a different appearance than the loading image 350, but may be displayed with the same appearance.

When the execution of the saving processing is instructed, the saving image 400 or the saving image 450 of the current game mode is displayed on the display device 36. When the saving image 400 is displayed, the save slot that the game data is saved last time in the first mode is designated by the cursor. Similarly, when the saving image 450 is displayed, the save slot that the game data is saved last time in the second mode is designated by the cursor. Therefore, the last time saving execution data 504g is included in the system file.

In different from the loading image 300 and the loading image 350, the saving image 400 and the saving image 450 cannot be exchanged. Therefore, it is possible to avoid the game data from being saved in association with the save slot of the game mode that is different from the game mode that the virtual game has been played.

As shown in FIG. 10, a folder image 402 is provided in the saving image 400, and a character string indicative of the first mode is displayed in a tabulation 402a of the folder image 402. Moreover, a plurality of save slots 410, 412, 414, 416, 418 and 420 are provided in the folder image 402. Moreover, a cursor 430 is provided in the saving image 400. The cursor 430 is a square frame having the same shape and the same size as those of each of the save slots 410-420. At the beginning when the saving image 400 is displayed, the cursor 430 designates the save slot 412, 414, 416, 418 or 420 that the game data is saved last time in the first mode.

However, each of the plurality of save slots 410, 412, 414, 416, 418 and 420 is the same save slot as each of the plurality of save slots 310, 312, 314, 316, 318 and 320 provided in the corresponding position in the loading image 300 shown in FIG. 8.

The save slot 410 is an image corresponding to a storage area of the flash memory 24 that the game data is saved automatically when playing the virtual game in the first mode. Therefore, in the saving image 400, the save slot 410 cannot be selected.

Other five save slots 412-420 are images corresponding to respective ones of the storage areas of the flash memory 24 that the virtual game is played in the first mode and the game data is saved according to an operation by the player.

A name is applied to each of the save slots 410-420, and a character string indicative of the name is displayed. As similar to the save slots 310-320 shown in FIG. 8, an automatically saved file, a first file, a second file, a third file, a fourth file and a fifth file are displayed. Although illustration is omitted, a character string indicative of information on the saved game data is displayed below the character string indicative of the name in each of the save slots 410-420. The information on the game data includes a date of saving the game data, an outline of the game part being played when the game data is saved, a name of the player, etc.

However, as for the save slot that the game data is not saved, character strings indicative of the name and the information on the game data are not displayed. Alternatively, only the name may be displayed.

In the saving image 400 shown in FIG. 10, the cursor 430 is moved by operating the cross button of the input device 30, so that another save slot (in FIG. 10, either one of the save slots 412, 414, 418 and 420) can be selected. When the cursor 430 is moved, a save slot (either of 412, 414, 418 and 420) that is designated by the cursor 430 after movement is selected.

Moreover, in the saving image 400, the A button of the input device 30 is operated, saving the game data is executed. That is, the game data is saved in association with either of the save slots 412-420 designated by the cursor 430. That is, the game data is stored in the corresponding storage area of the flash memory 24.

However, if the game data is automatically saved in the flash memory 24 when playing the virtual game in the first mode, the saving image 400 is not displayed. As an example, as a result of the game control processing, when the player character 152 is moved in the virtual space, when the predetermined flag is turned on, when talking with the non-player character 154, or when a predetermined time period elapsed, a condition for automatic saving is satisfied, and therefore, the game data is automatically saved. This applies to a case where the virtual game is played in the second mode.

As shown in FIG. 11, a folder image 452 is provided in the saving image 450, and a character string indicative of the second mode is displayed in a tabulation 452a of the folder image 452. Moreover, a plurality of save slots 460, 462, 464, 466, 468 and 470 are provided in the folder image 452. Moreover, a cursor 480 is provided in the saving image 450. The cursor 480 is a square frame having the same shape and the same size as those of each of the save slots 460-470. At the beginning when the saving image 450 is displayed, the cursor 480 designates the save slot 462, 464, 466, 468 or 470 that the game data is saved last time in the second mode.

However, each of the plurality of save slots 460, 462, 464, 466, 468 and 470 is the same save slot as each of the plurality of save slots 360, 362, 364, 366, 368 and 370 provided in the corresponding position in the loading image 350 shown in FIG. 9.

The save slot 460 is an image corresponding to a storage area of the flash memory 24 that the game data is saved automatically when playing the virtual game in the second mode. Therefore, in the saving image 450, the save slot 460 cannot be selected.

Other five save slots 462-470 are images corresponding to respective ones of the storage areas of the flash memory 24 that the virtual game is played in the second mode and the game data is saved according to an operation by the player.

A name is applied to each of the save slots 460-470, and a character string indicative of the name is displayed. As similar to the save slots 360-370 shown in FIG. 9, an automatically saved file, a first file, a second file, a third file, a fourth file and a fifth file are displayed. Although illustration is omitted, characters string indicative of information on the saved game data is displayed below the character string indicative of the name in each of the save slots 460-470. The information on the game data includes a date of saving the game data, an outline of the game part being played when the game data is saved, a name of the player, etc.

However, as for the save slot that the game data is not saved, a character string indicative of the name and the information on the game data are not displayed. Alternatively, only the name may be displayed.

In the saving image 450 shown in FIG. 11, the cursor 480 is moved by operating the cross button of the input device 30, so that another save slot (in FIG. 11, either one of the save slots 462, 464, 468 and 470) can be selected. When the cursor 480 is moved, a save slot (either of 462, 464, 468 and 470) that is designated by the cursor 480 after movement is selected.

Moreover, in the saving image 450, the A button of the input device 30 is operated, saving the game data is executed. That is, the game data is saved in association with either one of the save slots 462-470 designated by the cursor 480. That is, the game data is stored in the corresponding storage area of the flash memory 24.

However, if the game data is automatically saved in the flash memory 24 when playing the virtual game in the second mode, the saving image 450 is not displayed.

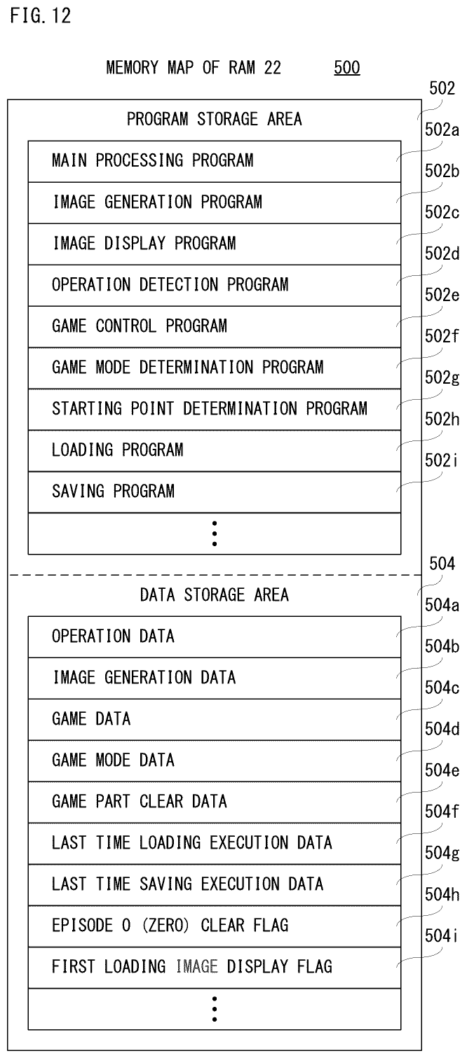

FIG. 12 is a view showing a non-limiting example memory map 500 of the RAM 22 of the game apparatus 10 shown in FIG. 1. As shown in FIG. 12, the RAM 22 includes a program storage area 502 and a data storage area 504. The program storage area 502 is stored with an application program of the virtual game (i.e., game program) according to the embodiment, which is an example of an information processing program. The game program includes a main processing program 502a, an image generation program 502b, an image display program 502c, an operation detection program 502d, a game control program 502e, a game mode determination program 502f, a starting point determination program 502g, a loading program 502h, a saving program 502i, etc.

In addition, the game program may be stored in advance in the flash memory 24, or may be acquired from an external server or another game apparatus 10 via a network such as Internet. Moreover, the game program may be acquired from an external memory attachable to or detachable from the game apparatus 10, such an optical disk, a USB memory or a memory card. However, a part of the game program is stored in the flash memory 24, and other parts thereof may be acquired from the external server, other game apparatus 10 or the external memory. These also apply to the image generation data 504b described later.

The main processing program 502a is a program for processing a main routine of the game program of the embodiment. The image generation program 502b is a program for generating, using the image generation data 504b, data of various kinds of images or images. The image display program 502c is a program for outputting the data of the image or image generated according to the image generation program 502b to the display device 36. Therefore, various kinds of images, such as the main menu image 100, the game image 150, the episode selection image 200, the game starting point selection image 250, the loading images 300 and 350, the saving images 400 and 450, etc. are displayed on the display device 36.

The operation detection program 502d is a program for detecting an operation by the player. In the embodiment, the operation of various kinds of push buttons, keys or switches provided on the input device 30 are detected.

The game control program 502e is a program for executing the game control processing of the virtual game of the embodiment.

The game mode determination program 502f is a program for selecting and determining the game mode as the first mode or the second mode according to an operation by the player. Moreover, the game mode determination program 502f is also a program for determining, when the saved game data is loaded during the play of the virtual game, the game mode as the first mode or the second mode that is set at the time that this game data is saved.

The starting point determination program 502g is a program for selecting and determining the starting point of the game part according to an operation of the player when the game mode is determined as the second mode.

The loading program 502h is a program for loading the saved game data according to an operation by the player.

The saving program 502i is a program for saving the game data in the flash memory 24 automatically or according to an operation by the player.

Although illustration is omitted, the program storage area 502 is stored with other programs, such as a communication program for communicating with the server or other game apparatus 10, a sound output program for generating and outputting a required sound in the virtual game, etc.

Moreover, the data storage area 504 is stored with the operation data 504a, the image generation data 504b, the game data 504c, game mode data 504d, game part clear data 504e, the last time loading execution data 504f, the last time saving execution data 504g, an episode 0 (zero) clear flag 504h and a first loading image display flag 504i.

The operation data 504a is operation data that is input from the input device 30, and is stored according to a time series. The operation data 504a is eliminated if used for processing by the processor 20.

The image generation data 504b includes data for generating the data of various kinds of images or mages, such as polygon data and texture data, etc.

The game data 504c is data including various kinds of parameters in the virtual game, and is updated by the game control processing. As an example, the data includes parameters, such as positions of respective characters and respective objects in the virtual space, hit point values of the respective characters and the respective objects, kinds of items that the respective characters possess, the number of the possessed items, etc.

The game mode data 504d is data that indicates that the current game mode is the first mode or the second mode.

The game part clear data 504e is data that indicates whether each of the plurality of game parts constituting the scenario has been cleared. For example, the game part clear data 504e has the same number of bits as the number of all the game parts, in which “1” is set to the bit corresponding to the game part having been cleared and “0” is set to the bit corresponding to the game part not having been cleared.

The last time loading execution data 504f is data that indicates the game mode that the game data is saved last time and the save slot with which this is associated.

The last time saving execution data 504g is data that indicates the save slot with which the game data saved last time is associated, for each game mode.

The episode 0 (zero) clear flag 504h is a flag for determining whether the episode 0 has been cleared. When the episode 0 is cleared, the episode 0 clear flag 504h is turned on, and when the episode 0 is not cleared, the episode 0 clear flag 504h is turned off. As an example, the processor 20 turns on or turns off the episode 0 clear flag 504h based on whether the episode 0 has been cleared by referring to the game part clear data 504e at the time of the start of the virtual game. However, the episode 0 clear flag 504h may be included in the system file.

The first loading image display flag 504i is a flag for determining whether the loading image 300 of the first mode is to be displayed. When the loading image 300 of the first mode is to be displayed, the first loading image display flag 504i is turned on, and when the loading image 350 of the second mode is not to be displayed, the first loading image display flag 504i is turned off.

Although illustration is omitted, the data storage area 504 is stored with other data required for the information processing of the virtual game, and is provided with a counter(s) or a timer(s).

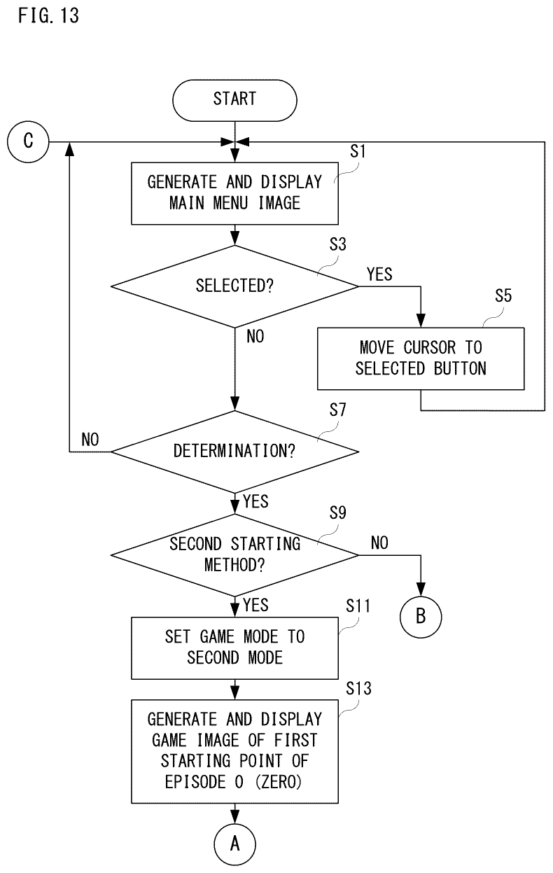

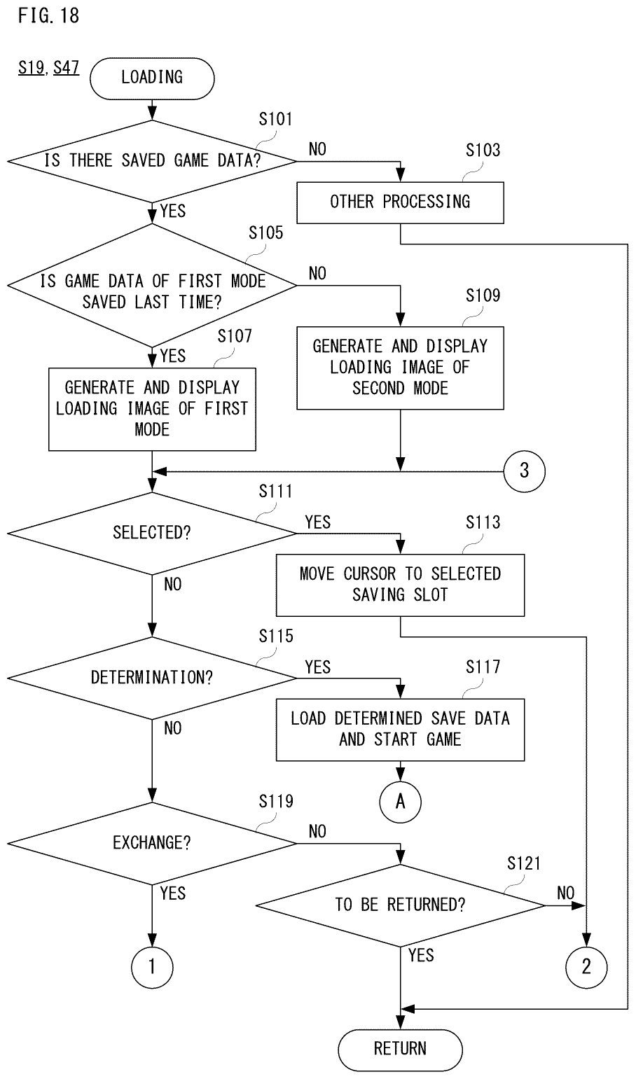

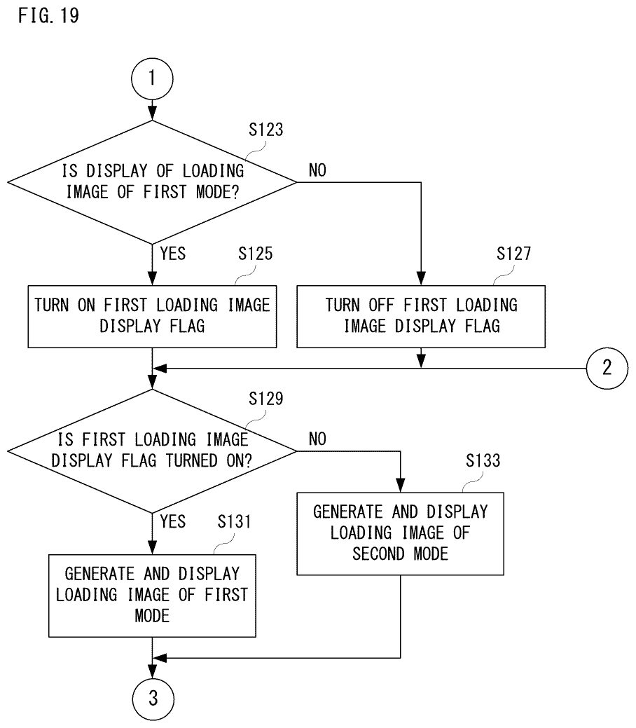

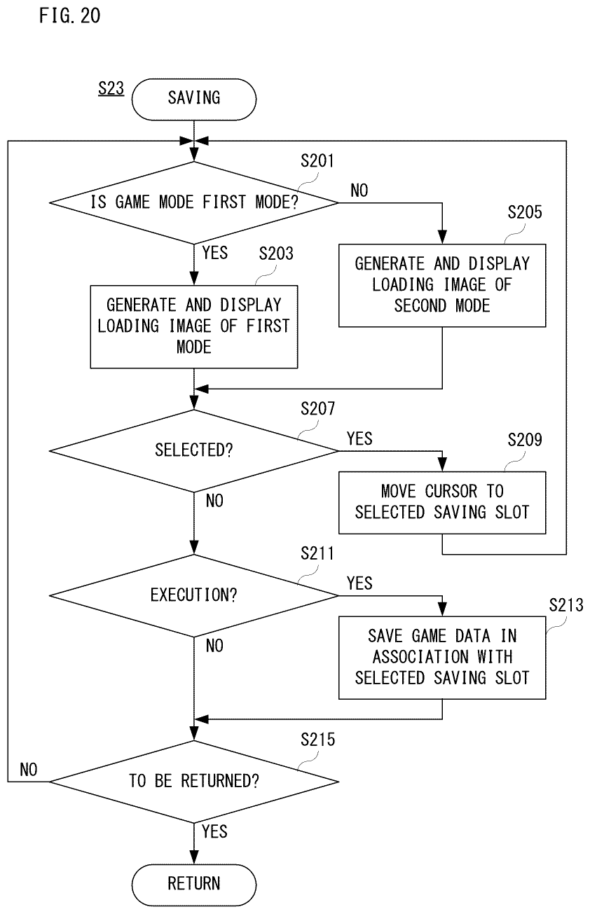

FIG. 13-FIG. 17 are flowcharts showing non-limiting example overall processing of the virtual game of the processor 20 shown in FIG. 1. Moreover, FIG. 18 and FIG. 19 are flowcharts showing non-limiting example loading processing by the processor 20 shown in FIG. 1. FIG. 20 is a flowchart showing non-limiting example saving processing by the processor 20 shown in FIG. 1.

However, processing of respective steps of the flowcharts shown in FIG. 13-FIG. 20 are mere examples, and if the same or similar result is obtainable, an order of the respective steps may be exchanged. Moreover, in the embodiment, it will be described that the processing of the respective steps of the flowcharts shown in FIG. 13-FIG. 20 are basically executed by the processor 20; however, some steps may be executed by a processor(s) and/or a dedicated circuit(s) other than the processor 20.

In the following overall processing of the virtual game, the processor 20 acquires the operation data 504a that is input from the input device 30, and generates and outputs the image data of the game image for each predetermined time period (e.g., 1/60 seconds or 1/30 seconds) by executing information processing according to a scene based on the operation data 504a. In the following, as for generation of the image data corresponding to the image, only a specific scene in the information processing will be described.

As shown in FIG. 13, if the overall processing of the virtual game is started, the processor 20 generates and displays the main menu image 100 in a step S1. Here, the processor 20 generates the image data corresponding to the main menu image 100 as shown in FIG. 2, and instructs the display driver 32 to output the generated image data. In the following, this applies to cases where other images such as the game image 150, etc. are generated and displayed.

Although illustration is omitted, before executing the processing of the step S1, the processor 20 loads the system file and stores the game part clear data 504e, the last time loading execution data 504f and the last time saving execution data 504g to the data storage area 504.

In a next step S3, it is determined whether the main menu is selected. Here, the processor 20 determines whether there is any operation of the up-direction button or the down-direction button of the cross button in the input device 30. If “YES” is determined in the step S3, that is, if the main menu is selected, in a step S5, the cursor 110 is moved to the selected button 102, 104 or 106, and then, the process returns to the step S1. Therefore, the main menu image 100 that the cursor 110 is moved is generated and displayed. That is, the main menu image 100 is updated.

On the other hand, if “NO” is determined in the step S3, that is, if the main menu is not selected, it is determined, in a step S7, whether it is determination of the main menu. Here, the processor 20 determines whether the A button of the input device 30 is turned on in a state where any one of the buttons 102-106 is being selected.

If “NO” is determined in the S7, that is, if it is not determination of the main menu, the process returns to the step S1. On the other hand, if “YES” is determined in the S7, that is, if it is determination of the main menu, it is determined, in a step S9, whether it is determined that the virtual game is to be started by the second starting method.

However, the processor 20 determines that it is determined that the virtual game is to be started in the first mode when the A button is turned on in a state where the button 102 is being turned on. Moreover, the processor 20 determines that it is determined that the virtual game is to be started in the second mode when the A button is turned on in a state where the button 104 is being turned on. Furthermore, the processor 20 determines that it is determined that the virtual game is to be played by loading the saved game data when the A button is turned on in a state where the button 106 is being turned on.

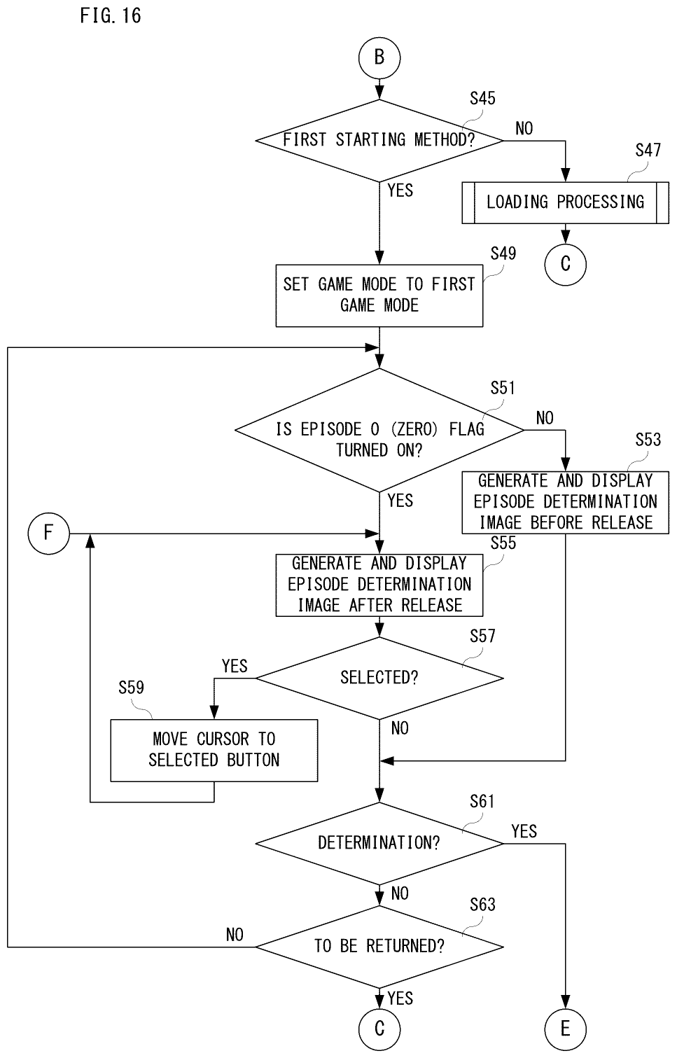

If “NO” is determined in the step S9, that is, if it is not determined that the virtual game is to be started by the second starting method, the process proceeds to a step S45 of FIG. 16. On the other hand, if “YES” is determined in the step S9, that is, if it is determined that the virtual game is to be started by the second starting method, the game mode is set as the second mode in a step S11. That is, the processor 20 stores or updates the game mode data 504d indicating the second mode.

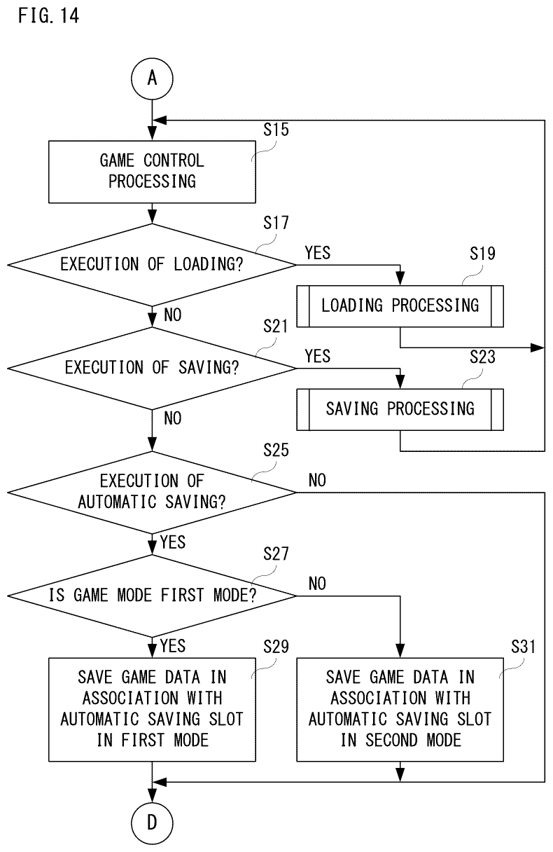

In a next step S13, the game image 150 at the starting point of the first game part of the episode 0 (zero) is generated and displayed. Subsequently, the information processing is executed based on the acquired operation data 504a in a step S15 shown in FIG. 14, and the game control processing performing generation and display of the game image 150 based on a result of the information processing is executed.

Subsequently, it is determined, in a step S17, whether the loading is to be executed. Here, the processor 20 determines whether the Y button of the input device 30 is operated. If “YES” is determined in the step S17, that is, if it is determined that the loading is to be executed, the loading processing described later (see FIG. 18 and FIG. 19) in a step S19, and the process returns to the step S15.

On the other hand, if “NO” is determined in the step S17, that is, if it is not determined that the loading is to be executed, it is determined, in a step S21, whether the saving is to be executed. Here, the processor 20 determines whether the X button of the input device 30 is operated.

If “YES” is determined in the step S21, that is, if is determine that the saving is to be executed, the saving processing described later (see FIG. 20) is executed in a step S23, and the process returns to the step S15. On the other hand, if “NO” is determined in the step S21, that is, if it is determined that the saving is not to be executed, the process proceeds to a step S25.

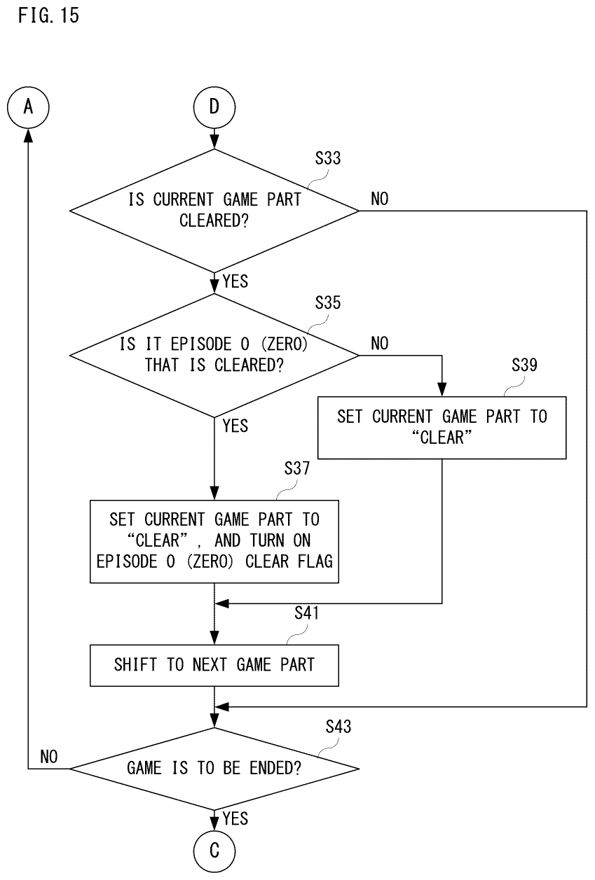

In the step S25, it is determined whether the automatic saving is to be executed. Here, the processor 20 determines whether the above-described condition for performing the automatic saving is satisfied. If “NO” is determined in the step S25, that is, if the automatic saving is not to be executed, the process proceeds to a step S33 shown in FIG. 15. On the other hand, if “YES” is determined in the step S25, that is, if the automatic saving is to be executed, it is determined, in a step 27, whether the current game mode is the first mode. Here, the processor 20 determines whether the game mode data 504d indicates the first mode.

If “YES” is determined in the step S27, that is, if the current game mode is the first mode, in a step S29, the game data 504c is saved in the flash memory 24 in association with the save slot 410 for automatically saving in the first mode, and the process proceeds to a step S33. On the other hand, if “NO” is determined in the step S29, that is, if the current game mode is the second mode, in a step S31, the game data 504c is saved in the flash memory 24 in association with the save slot 460 for automatically saving in the second mode, and the process proceeds to a step S37.

As shown in FIG. 15, in the step S33, it is determined, based on the result of the game control processing, whether the current game part is cleared. If “NO” is determined in the step S33, that is, if the current game part is not cleared, the process proceeds to a step S43. On the other hand, if “YES” is determined in the step S33, that is, if the current game part is cleared, it is determined, in a step S35, whether what is cleared is the episode 0. Here, the processor 20 determines whether it is determined whether the game part that is determined having been cleared in the step S33 is a game part of the tail end of the episode 0.

If “YES” is determined in the step S35, that is, if the episode 0 is cleared, the process proceeds to the step S37 so as to set that the current game part is cleared, the episode 0 clear flag 504h is turned on, and then, the process proceeds to a step S41. On the other hand, if “NO” is determined in the step S35, that is, if the episode 0 is not cleared, the process proceeds to a step S39 so as to set that the current game part is cleared, and then, process proceeds to the step S41. In the step S41, the game part is shifted to a next game part, and the process proceeds to the step S43.

In the step S43, it is determined whether the game is to be ended. Here, the processor 20 determines whether the game end is instructed by the player. If “NO” is determined in the step S43, that is, if the game is not to be ended, the process returns to the step S15 shown in FIG. 14. On the other hand, if “YES” is determined in the step S43, that is, if the game is to be ended, the process returns to the step S1 shown in FIG. 13.

As described above, if “NO” is determined in the step S9, it is determined, in a step S45 shown in FIG. 16, whether it is determined that the game is to be started by the first method. If “NO” is determined in the step S45, that is, if it is determined that the virtual game is to be played by loading the save data, the loading processing described later is executed in a step S47, and then, the process returns to the step S1.

On the other hand, when if “YES” is determined in the step S45, that is, if it is determined that the game is to be started by the first starting method, the game mode is set as the first mode in a step S49, it is determined, in a step S51, whether the episode 0 clear flag 504h is turned on.

If “NO” is determined in the step S51, that is, if the episode 0 clear flag 504h is turned off, in a step S53, the episode selection image 200 before release as shown in FIG. 5 is generated and displayed, and then, the process proceeds to a step S61. On the other hand, if “YES” is determined in the step S51, that is, if the episode 0 clear flag 504h is turned on, in a step S55, the episode selection image 200 after release as shown in FIG. 4 is generated and displayed, and then, the process proceeds to a step S57.

In the step S57, it is determined whether either of the buttons 202-210 is selected. Here, the processor 20 determines whether there is any operation of the up-direction button or the down-direction button of the cross button in the input device 30. If “NO” is determined in the step S57, that is, if neither of the buttons 202-210 is selected, the process proceeds to the step S61. On the other hand, if “YES” is determined in the step S57, that is, if either of the buttons 202-210 is selected, the cursor 220 is moved to the selected button 202, 204, 206, 208 or 210 in a step S59, and the process returns to the step S55. Therefore, if the processing of the step S55 is executed, the cursor 220 is displayed to be superposed on the button 202, 204, 206, 208 or 210 after movement in the episode selection image 200 after release, and the information on the episode corresponding to the button 202, 204, 206, 208 or 210 that is designated by the cursor 220 is displayed in the display area 232.

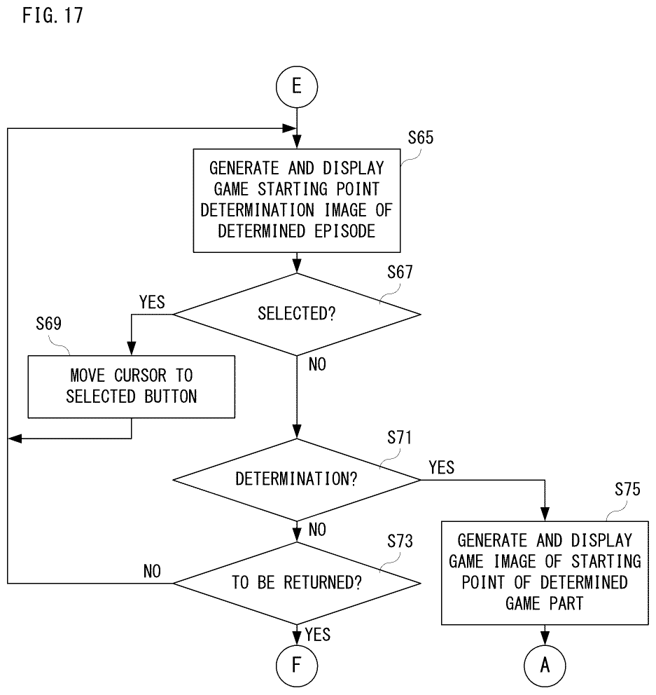

In the step S61, it is determined whether it is determination. Here, the processor 20 determines whether the A button of the input device 30 is turned on. If “YES” is determined in the step S61, that is, if it is determination, the process proceeds to a step S65 shown in FIG. 17. On the other hand, if “NO” is determined in the step S61, that is, if it is not determination, it is determined, in a step S63, the process is to be returned to the main menu. Here, the processor 20 determines whether the B button of the input device 30 is turned on.

If “NO” is determined in the step S63, that is, if not returning to the main menu, the process returns to the step S51. On the other hand, if “YES” is determined in the step S63, that is, if returning to the main menu, the process returns to the step S1.

As shown in FIG. 17, in the step S65, the game starting point selection image 250 for the determined episode is generated and displayed. In a next step S67, it is determined whether the button 260 is selected. Here, the processor 20 determines whether the left-direction button or the right-direction button of the cross button in the input device 30 is operated.

If “YES” is determined in the step S67, that is, if it is selection of the button 260, the cursor 270 is moved to the selected button 260 in a step S69, and the process returns to the step S65. Therefore, the game starting point selection image 250 is updated. On the other hand, if “NO” is determined in the step S67, that is, if it is not selection of the button 260, it is determined, in a step S71, whether it is determination. Here, the processor 20 determines whether the A button of the input device 30 is turned on.

If “YES” is determined in the step S71, that is, if it is determination, in a step S75, the game image 150 of the starting point of the game part corresponding to the determined button 260 is generated and displayed, and then, the process proceeds to the step S15 shown in FIG. 14. On the other hand, if “NO” is determined in the step S71, that is, if it is not determination, it is determined, in a step S73, whether to return to the episode selection image 200 after release. Here, the processor 20 determines whether the B button of the input device 30 is turned on.

If “NO” is determined in the step S73, that is, if not returning to the episode selection image 200 after release, the process returns to the step S65. On the other hand, if “YES” is determined in the step S73, that is, if returning to the episode selection image 200 after release, the process returns to the step S55 shown in FIG. 16.

FIG. 18 and FIG. 19 are flowcharts showing non-limiting example loading processing indicated in the step S19 shown in FIG. 14 and the step S53 shown in FIG. 16. As shown in FIG. 18, when starting the loading processing, the processor 20 determines, in a step S101, whether there is any saved game data. Here, the processor 20 determines whether there is already any saved game data in the first mode and/or the second mode.

If “YES” is determined in the step S101, that is, if there is already the saved game data in the first mode or the second mode, the process proceeds to a step S105. On the other hand, if “NO” is determined in the step S101, that is, if there is no saved game data, other processing is executed in a step S103, and the process returns to the overall processing of the virtual game. In the step S103, the processor 20 ends the loading processing without displaying the loading image.

In the step S105, it is determined whether the game data of the first mode is saved last time. Here, the processor 20 determines whether that last time saving execution data 405g is indicates that the game data of the first mode is loaded.

If “YES” is determined in the step S105, that is, if the game data in the first mode is saved last time, the loading image 300 in the first mode as shown in FIG. 8 is generated and displayed in a step S107, and the process proceeds to a step S111. On the other hand, if “NO” is determined in the step S105, that is, if the game data in the second mode is saved last time, the loading image 350 in the second mode as shown in FIG. 9 is generated and displayed in a step S109, and the process proceeds to the step S111.

In the step S111, it is determined whether either of the save slots 310-320 or either of the save slots 360-370 is selected. In a description of the loading processing below, when the loading image 300 of the first mode is being displayed, i.e., when the first loading image display flag 504i is turned on, a save slot indicates either of the save slots 310-320 and a cursor indicates the cursor 330. Moreover, when the loading image 350 of the second mode is being displayed, i.e., when the first loading image display flag 504i is turned off, a save slot indicates either of the save slots 360-370 and a cursor indicates the cursor 380.

If “YES” is determined in the step S111, that is, if it is selection of a save slot, the cursor is moved to the selected save slot in a step S113, and the process proceeds to a step S129 shown in FIG. 19. On the other hand, if “NO” is determined in the step S111, that is, if it is not selection of a save slot, it is determined, in a step S115, whether it is determination. Here, the processor 20 determines whether the A button of the input device 30 is turned on.

If “YES” is determined in the step S115, that is, if it is determination, at a step S117, the game data of the determined save slot is loaded, and the game is started in the game mode at the time that the game data is saved, and then, the process proceeds to the step S15. At this time, the processor 20 ends the loading processing. In this step S117, the game data 504c corresponding to the save slot that is determined in the loading image 300 of the first mode or the loading image 350 of the second mode is read into the RAM 22, and the game mode at the time that the game data 504c is saved is set, and the game is resumed from the point (or position) that the game data 504c is saved. At this time, the game image 150 for the saved point is generated and displayed. Moreover, the game mode data 504d is updated to the data indicating the game mode that is set.

On the other hand, if “NO” is determined in the step S115, that is, if it is not determination, it is determined, in a step S119, whether it is necessary to exchange the game mode. Here, the processor 20 determines whether the R button of the input device 30 is turned on when the loading image 300 is being displayed, or whether the L button of the input device 30 is turned on when the loading image 350 is being displayed.

If “YES” is determined in the step S119, that is, if exchanging the game mode, the process proceeds to a step S123 shown in FIG. 19. On the other hand, if “NO” is determined in the step S119, that is, if not exchanging the game mode, it is determined, in a step S121, whether the processing is to be returned to the overall processing of the virtual game. Here, the processor 20 determines whether the B button of the input device 30 is turned on.

If “NO” is determined in the step S121, that is, if not returning to the overall processing of the virtual game, the process proceeds to the step S129. On the other hand, if “YES” is determined in the step S121, that is, if returning to the overall processing of the virtual game, the loading processing is ended and the process returns to the overall processing of the virtual game.

As shown in FIG. 19, in a step S123, it is determined whether the loading image 300 of the first mode is to be displayed. If “YES” is determined in the step S123, that is, if the loading image 300 of the first mode is to be displayed, the first loading image display flag 504i is turned on in a step S125, and the process proceeds to the step S129. On the other hand, if “NO” is determined in the step S123, that is, if the loading image 350 of the second mode is to be displayed, the first loading image display flag 504i is turned off in a step S127, and the process proceeds to the step S129.

In the step S129, it is determined whether the first loading image display flag 504i is turned on. If “YES” is determined in the step S129, that is, if the first loading image display flag 504i is turned on, the loading image 300 of the first mode is generated and displayed in a step S131, and the process returns to the step S111. On the other hand, if “NO” is determined in the step S129, that is, if the first loading image display flag 504i is turned off, the loading image 350 of the second mode is generated and displayed in a step S133, and the process returns to the step S111.

FIG. 20 is a flowchart showing non-limiting example saving processing of the step S23 shown in FIG. 14. As shown in FIG. 20, if the saving processing is started, the processor 20 determines, in a step S201, whether the game mode is the first mode.

If “YES” is determined in the step S201, the saving image 400 of the first mode is generated and displayed in a step S203, and the process proceeds to a step S207. In the beginning that the saving processing is started, the processor 20 displays the cursor 430 so that the save slot 410, 412, 414, 416, 418 or 420 that the game data of the first mode is saved last time is to be designated with referring to the last time saving execution data 504g. On the other hand, if “NO” is determined in the step S201, the saving image 450 of the second mode is generated and displayed in a step S205, and the process proceeds to the step S207. In the beginning that the saving processing is started, the processor 20 displays the cursor 480 so that the save slot 460, 462, 464, 466, 468 or 470 that the game data of the second mode is saved last time is to be designated with referring to the last time saving execution data 504g.

In the step S207, it is determined whether either of the save slots 410-420 or either of the save slots 460-470 is selected. In a description of the saving processing below, when the saving image 400 of the first mode is being displayed, i.e., when the game mode is the first mode, a save slot indicates either of the save slots 410-420 and a cursor indicates the cursor 430. Moreover, when the saving image 450 of the second mode is being displayed, i.e., when the game mode is the second mode, a save slot indicates either of the save slots 460-470 and a cursor indicates the cursor 480.

If “YES” is determined in the step S207, that is, if the save slot is selected, the cursor is moved to the selected save slot in a step S209, and the process returns to the step S201. On the other hand, if “NO” is determined in the step S207, that is, if it is not selection of the save slot, it is determined, in a step S211, whether it is execution of the saving. Here, the processor 20 determines whether the A button of the input device 30 is turned on.

If “NO” is determined in the step S211, that is, if it is not execution of the saving, the process proceeds to a step S215. On the other hand, if “YES” is determined in the step S211, that is, if it is execution of the saving, in a step S213, the game data 504c is saved in the flash memory 24 in association with the selected save slot, and then, the process proceeds to the step S215.

In the step S215, it is determined whether the process is to be returned to the overall processing of the virtual game. Here, the processor 20 determines whether the B button of the input device 30 is turned on. If “NO” is determined in the step S215, the process returns to the step S201. On the other hand, if “YES” is determined in the step S215, the saving processing is ended, the process returns to the overall processing of the virtual game.

According to the embodiment, when the first starting method is determined, even when the virtual game is played at the first time, the virtual game is playable from any one of the plurality of predetermined game starting points, and it becomes possible to play the virtual game from any one of other game starting points as the virtual game progresses.

In addition, in the embodiment, if the episode 0 (zero) is cleared, the episode 1 and subsequent episodes is playable; however, the episode 1 and subsequent episodes may be made playable from the beginning without clearing the episode 0. In such a case, if the virtual game is started first and the first starting method is determined, in each of the episodes 0-4, it is possible to play from the starting point of the first game part.

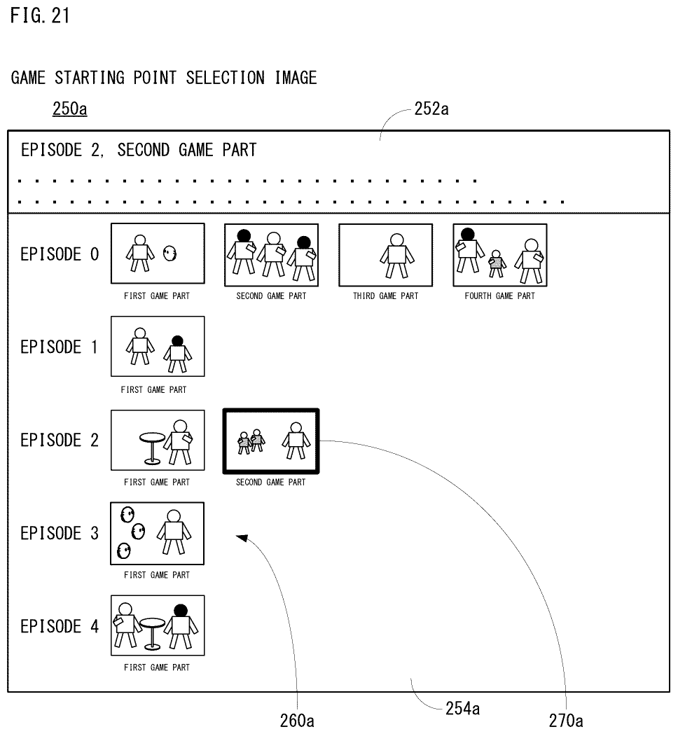

Moreover, although the starting point is determined after determining the episode in the first starting method in the embodiment, it may be possible to determine the episode and the starting point of the game part simultaneously. FIG. 21 is a view showing another non-limiting example game starting point selection image 250a.

As shown in FIG. 21, in the game starting point selection image 250a, a display area 252a and a display area 254a are included. The display area 252a displays a character string indicating the episode corresponding to a button 260a the is designated by a cursor 270a and the number of the game part, and the contents of a description of this game part (e.g., outline). The display area 254a displays, for each episode, the button 260a corresponding to each of the starting point of one or more game parts that are playable.

In an example shown in FIG. 21, the button 260a corresponding to the starting point of the second game part of the episode 2 is designated by the cursor 270a. That is, the starting point of the second game part of the episode 2 is selected. Therefore, a character string indicating the episode 2 and the number of the second game part, and the outline of this game part are displayed in the display area 252a. When the player operates the A button of the input device 30, the virtual game is started from the starting point corresponding to the button 260a that is designated by the cursor 270a. That is, in a further game starting point selection images 250a, it is possible to play the virtual game by determining the episode and the starting point of the game part simultaneously.

In addition, in the embodiment, aside from the game data, the system file is saved, but the system file may be stored to be included in each game data. In such a case, when the game data is saved, the system file of other game data is also updated.

Moreover, in the embodiment, the overall processing of the virtual game, the loading processing and the saving processing shown in FIG. 13-FIG. 20 are all executed by the processor 20 of the game apparatus; however, a part or all of them may be executed by an external computer capable of communicating with the game apparatus so that the game apparatus can acquire from the computer a result(s) of the processing in part or all. In such a case, a network game system or an information processing system is constituted by the game apparatus and the computer that is communicably connected with the game apparatus.

In addition, the structure of the game apparatus, various kinds of images, specific numeral values, etc. shown in the above-described embodiment(s) are mere examples, should not be limited and can be appropriately changed according to actual products.

Moreover, if the same or similar result is obtainable, an order of the respective steps shown in the flowcharts may be exchanged.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. One or more non-transitory computer-readable storage media having stored therein one or more game programs, wherein the game program is for a game that a scenario is sectioned into a plurality of successive game parts and a game starting point is set at a beginning of each of the plurality of game parts, wherein the game program causes one or more processors to execute game processing comprising:
displaying a selection image including at least one of first-type selection user interfaces and second-type selection user interfaces, the first-type selection user interfaces corresponding to respective game parts that are playable by the player when a previous game part is cleared, the second-type selection user interfaces corresponding to respective game parts that are playable by the player irrespective of whether a previous game part is cleared; and
starting the game from the game starting point of the game part corresponding to the selection user interface that is selected based on an input by the player from the selection user interfaces included in the selection image.

2. The storage medium according to claim 1, wherein the game processing further comprising:
determining based on an input by the player either a first game starting method or a second game starting method as a method of starting the game;
displaying the selection image to allow the player to select the selection user interface based on an input by the player, and starting the game from the game starting of the game part corresponding to the selection user interface that is selected by the player, when the first game starting method is determined; and
starting the game from the starting point of a first game part of the scenario, when the second game starting method is determined.

3. The storage medium according to claim 2, wherein the game processing further comprising: starting the game from the starting point of the first game part of the scenario without displaying the selection image, when the second game starting method is determined.

4. The storage medium according to claim 2, wherein the game processing further comprising: displaying the selection image including the first-type selection user interfaces corresponding to the game part that the previous game part is cleared in the game that is started by the first game starting method and to the game part that the previous game part is cleared in the game that is started by the second game starting method.

5. The storage medium according to claim 4, wherein the game processing further comprising:
displaying a first saving image including a plurality of first-type save slots to allow the player to select based on an input by the player, and storing the first-type save slot selected by the player and the save data of the game in association with each other, when saving that saves game data is instructed by the player during execution of the game that is started by the first game starting method; and
displaying a second saving image including a plurality of second-type save slots to allow the player to select based on an operation by the player, and storing the second-type save slot selected by the player and the save data of the game in association with each other, when the saving is instructed by the player during execution of the game that is started by the second game starting method.

6. The storage medium according to claim 5, wherein the game processing further comprising: displaying either a first loading image that includes the first-type save slots or a second loading image that includes the second-type save slots, when loading that reads-in the save data is instructed by the player;
resuming the game based on the save data corresponding to the first-type save slot that is selected based on a selection input by the player when the first loading image is being displayed;
displaying the second loading image according to an image change input by the player, when the first loading image is being displayed;
resuming the game based on the save data corresponding to the second-type save slot that is selected based on a selection input by the player, when the second loading image is being displayed; and
displaying the first loading image according to an image change input by the player, when the second loading image is being displayed.

7. The storage medium according to claim 6, wherein the game processing further comprising:
displaying the first loading image, when the save data stored at last is the save data regarding the game that is started by the first game starting method; and
displaying the second loading image, when the save data stored at last is the save data regarding the game that is started by the second game starting method.

8. The storage medium according to claim 6, wherein the game processing further comprising:
displaying the first loading image, when the game executed at last is the game that is started by the first game starting method; and
displaying the second loading image, when the game executed at last is the game that is started by the second game starting method.

9. The storage medium according to claim 6 wherein the game processing further comprising:
displaying the first loading image when the save data read-in at last is the save data regarding the game that is started by the first game starting method; and
displaying the second loading image when the save data read-in at last is the save data regarding the game that is started by the second game starting method.

10. The storage medium according to claim 6, wherein the plurality of first-type save slots include a first-type automatic save slot that is a slot corresponding to the save data regarding automatic saving, and the plurality of second-type save slots include a second-type automatic save slot that is a slot corresponding to the save data regarding automatic saving, wherein the game processing further comprising:
storing automatically the save data in association with the first-type automatic save slot, when an event that the save data of the game is to be saved during execution of the game that is started by the first starting method; and
storing automatically the save data in association with the second-type automatic save slot, when an event that the save data of the game is to be saved during execution of the game that is started by the second starting method.

11. The storage medium according to claim 1, wherein the game processing further comprising: displaying the selectin image that includes information regarding the game part corresponding to the selection user interface.

12. The storage medium according to claim 11, wherein the information regarding the game part includes at least one of a number of the game part corresponding to the selection user interface and a title of the game part.

13. The storage medium according to claim 11, wherein the information regarding the game part includes at least either a description of the game part corresponding to the selection user interface selected based on an input by the player or an image regarding the game part corresponding to the selection user interface.

14. The storage medium according to claim 1, wherein the game processing further comprising:
displaying the selection image not including the plurality of second-type selection user interfaces, when at least a predetermined game part including a first game part of the scenario is not cleared; and
displaying the selection image including the plurality of second-type selection user interfaces, when the predetermined game part is cleared.

15. The storage medium according to claim 1, wherein the game processing further comprising:
displaying the selection image including the plurality of second-type selection user interfaces as user interfaces each of which cannot be selected by the player, when at least a predetermined game part including a first game part of the scenario is not cleared; and
displaying the selection image including the plurality of second-type selection user interfaces as user interfaces each of which can be selected by the player, when the predetermined game part is cleared.

16. The storage medium according to claim 1, wherein the game processing further comprising:
displaying a mode selection image including a first mode selection user interface corresponding to the first game starting method and a second mode selection user interface corresponding to the second game starting method;
determining based on an input by the player either the first game starting method or the second game starting method as a game starting method;
displaying the mode selection image not including the first mode selection user interfaces, when at least a predetermined game part including a first game part of the scenario is not cleared; and
displaying the mode selection image including the first mode selection user interfaces, when the predetermined game part is cleared.

17. A game system comprising:
one or more processors; and
one or more memories including one or more programs that cause the one or more processors to execute game processing comprising:
displaying a selection image including a selection user interface that is designated according to an input by a player from first-type selection user interfaces and second-type selection user interfaces, the first-type selection user interfaces corresponding to respective game parts that become playable by the player after a previous game part is cleared, the second-type selection user interfaces corresponding to respective game parts that are playable by the player irrespective of whether a previous game part is cleared; and
starting the game from the game starting point of the game part corresponding to the selection user interface that is selected based on an input by the player from the selection user interfaces included in the selection image.

18. The game system according to claim 17, wherein the game processing further comprising:
determining based on an input by the player either a first game starting method or a second game starting method as a method of starting the game;
displaying the selection image to allow the player to select the selection user interface based on an input by the player, and starting the game from the game starting of the game part corresponding to the selection user interface that is selected by the player, when the first game starting method is determined; and
starting the game from the starting point of a first game part of the scenario, when the second game starting method is determined.

19. A game control method executing game processing of a game that a scenario is sectioned into a plurality of successive game parts and a game starting point is set at a beginning of each of the plurality of game parts, wherein the one or more processors execute:
displaying a selection image including a selection user interface that is designated according to an input by a player from first-type selection user interfaces and second-type selection user interfaces, the first-type selection user interfaces corresponding to respective game parts that become playable by the player after a previous game part is cleared, the second-type selection user interfaces corresponding to respective game parts that are playable by the player irrespective of whether a previous game part is cleared; and
starting the game from the game starting point of the game part corresponding to the selection user interface that is selected based on an input by the player from the selection user interfaces included in the selection image.

20. The game control method according to claim 19, wherein the one or more processors execute:
determining based on an input by the player either a first game starting method or a second game starting method as a method of starting the game;
displaying the selection image to allow the player to select the selection user interface based on an input by the player, and starting the game from the game starting of the game part corresponding to the selection user interface that is selected by the player, when the first game starting method is determined; and
starting the game from the starting point of a first game part of the scenario, when the second game starting method is determined.
